(19) United States
(12) Patent Application Publication
(10) Pub. No.: US 2005/0266183 A1
(43) Pub. Date: Dec. 1, 2005

(54) Ink jet recording material and manufacturing method of the ink jet recording material

(75) Inventors: Kouji Tashiro, Tokyo (JP); Shinichi Suzuki, Tokyo (JP); Takahiko Nojima, Tokyo (JP); Yosuke Sone, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/135,594

(22) Filed: May 23, 2005

(30) Foreign Application Priority Data
May 31, 2004 (JP) 2004-161890
Oct. 22, 2004 (JP) 2004-308171

(51) Int. Cl. B41M 5/00

(52) U.S. Cl. 428/32.34

(57) ABSTRACT

The ink jet recording material having: a support; a porous layer containing a hydrophilic binder and articulates, formed onto a support; wherein a coating solution is provided onto the porous layer, the coating solution being adapted to make a property to a specific light different from a property of a lower structure.

### BACKGROUND OF THE INVENTION

1. Field of the Invention

The present invention relates to an ink jet recording material and a manufacturing method of the ink jet recording material, particularly to an ink jet recording material formed in such a structure in which a porous layer is provided on a support and a coating solution is applied onto the porous layer, and a manufacturing method of the ink jet recording material formed in such a structure.

2. Description of the Related Art

In recent years, the quality of images obtained by printing in the ink jet recording system has been improved rapidly and is about reaching closely to the quality of silver salt photographs. In order to achieve to provide images with high quality by means of the ink jet recording system similarly to those of silver salt photographs, various attempts for improving the ink jet recording materials to be used have been made vigorously. As a result, for example, a method using an ink jet recording material in which a porous layer including fine voids is provided onto a support having high smoothness as an ink-absorbing layer (an ink-receiving layer) is becoming one of the methods with which the closest quality to that of photographic images can be achieved, because the ink jet recording material structured as described above has high ink-absorbing and high drying properties.

The ink jet recording material as described above can be obtained by coating a coating solution that forms a porous layer containing a hydrophilic binder and particulates onto a support such as a paper.

Furthermore, an attempt to obtain an ink jet recording material having higher performance, which can be obtained by applying another coating solution that provides the recording material with functions of varying the color and/or strengthening the porous layer and so on onto the coating having been formed with a coating solution for forming the porous layer, has been made and disclosed (refer to JP-Tokukai-2002-331745).

In the disclosure referred to hereinabove, the additives for providing various functions as described above are not added directly into the coating solution for forming the porous layer. This is because of such a reason that disadvantages, such as agglomeration, coating defect and the like, may be caused if the additives are added into the coating solution directly, whereas various functions may be provided to the porous layer without problems when the additives are applied (overcoated) onto the porous layer in the form of a solution.

With this method, as described above, the recording material may be provided with various functions because less constrains will be imposed to the coating solution.

However, the coating solution to be coated (overcoated) in the following step is transparent in many cases and is sunk into the porous layer having been coated previously. As a result, it is impossible to use the conventional method for detecting the accuracy of the coating. Furthermore, since high coating accuracy is required for the ink jet recording system so as not to cause unevenness in the density, the quality guarantee will be the critical issue.

As a quality guarantee method for the common coatings, there is a method to irradiate an object with laser light to thereby determine the disturbance in the specularly reflected light. With this method, it is possible to detect defects such as pin holes. However, once the coating was performed and a layer with water-absorbing property was formed, and another coating solution is then applied onto the layer once more, it becomes hard to detect the defects because the coating solution applied later is absorbed into the previous layer.

A method to monitor the stability of a coating solution in the form of a film when performing curtain coating is proposed as a method for monitoring the coating accuracy based on the supply condition of the coating solution instead of the performance after the coating (refer to JP-Tokukai-2000-117173).

Further, a method using non-visible light as a light source is also disclosed (refer to JP-Tokukaihei-8-338814).

However, although the method disclosed in the foresaid JP-Tokukai-2000-117173 can be used for carrying out accurate monitoring of the coating solution supply, the uniformity in the coating solution supply does not always accord to the uniformity of the coated surface with this method because the wetting property of the coating solution with the lower layer is the important factor at the time of performing the coating onto the layer once more.

On the other hand, the method disclosed in the foresaid JP-Tokukaihei-8-338814 is a detection method in a single layer and for observing transmitted light, not for determining the reflected light and fluorescence. In addition, in this method, it is not configured such that a substance having absorbing property for non-visible light is intentionally contained.

### SUMMARY OF THE INVENTION

In accordance with the first aspect of the present invention, the ink jet recording material comprises:
a support;
a porous layer containing a hydrophilic binder and particulates, formed onto a support;
wherein a coating solution is provided onto the porous layer, the coating solution being adapted to make a property to a specific light different from a property of a lower structure.

In accordance with the second aspect of the present invention, the method for manufacturing an ink jet recording material comprises:
forming a porous layer containing a hydrophilic binder and particulates on a support;
providing a coating solution on the porous layer to form the ink jet recording material, the coating solution being adapted to make a property to a specific light different from a property of the lower structure; and
detecting a response of the ink jet recording material to the specific light by irradiating the specific light.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a view showing a part of an ink jet recording material according to one embodiment for the present invention;

FIG. 2 is a view showing a part of the ink jet recording material provided with an undercoat layer;

FIG. 3 is a view showing a process for manufacturing the ink jet recording material according to the embodiment;

FIG. 4 is a view showing an inspection apparatus for carrying out the performance inspection of the ink jet recording material according to the embodiment;

FIG. 5 is a view showing a part of the ink jet recording material in which a second costing solution is coated but not uniformly;

FIG. 6 is a view showing a part of the ink jet recording material in which a second costing solution is coated but not uniformly; and

FIG. 7 is a view showing a part of the ink jet recording material in which a second costing solution is coated but uniformly.

### DETAILED DESCRIPTION OF THE PREFERRED EMBODIMENTS

Hereinafter, the embodiments of the ink jet recording material and the manufacturing method of the ink jet recording material according to the present invention will be described with reference to the appended drawings. However, it is to be noted that the present invention is not limited to the exemplary embodiments shown in the drawings.

In the first place, the details of the ink jet recording material according to the present invention will now be described.

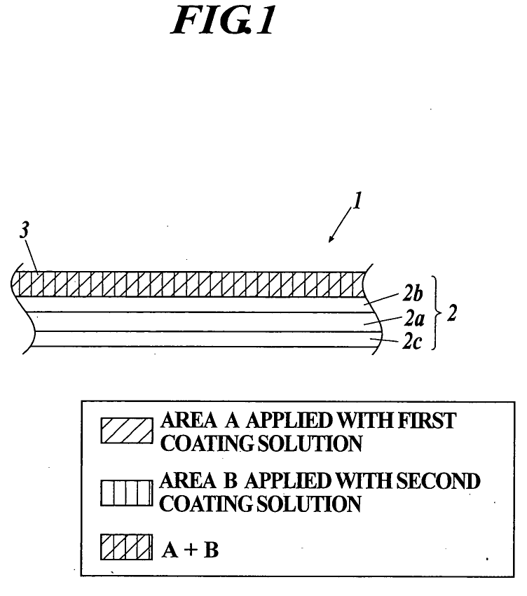

As shown in FIG. 1, an ink jet recording material 1 of the present invention is prepared by applying an aqueous first coating solution A containing a hydrophilic binder and particulates onto a support 2 to form a porous layer containing voids and applying (overcoating) a second coating solution B having a predetermined function onto the support to cause the second coating solution B to permeate into the porous layer 3 having been formed with the first coating solution A.

For the support 2 used for manufacturing the ink jet recording material 1 of the present invention, a water-absorbing support (e.g., a paper and the like) or a non-water-absorbing support may be used. However, it is preferable to use a non-water-absorbing support because prints with higher quality can be obtained therewith.

When the non-water-absorbing support is used, it is possible not only to obtain the prints with higher quality but also to prevent the intrinsic effect of the additives from being deteriorated, the deterioration results from a phenomenon that the components of the additives contained in the overcoated second coating solution permeate and diffuse after the coating into the support. For example, when a water-absorbing support is used, the support, the undercoat layer (will be described later) and the additive in the second coating solution that has a property different from that of the first coating solution permeate and diffuse into the support. As a result, there is such a possibility that the advantageous effect of the performance inspection method for the ink jet recording material according to the present invention to particular light (for example, non-visible light such as ultraviolet radiation) may not be sufficiently exerted. However, when the support is a non-water-absorbing support, such a disadvantage can be prevented from occurring.

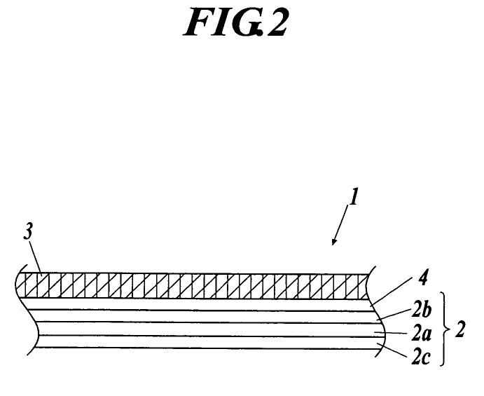

Examples of the non-water-absorbing support include a support made from a plastic resin film and the support 2 prepared by coating both sides of a paper 2a with resin layers 2b, 2c comprising a plastic resin film as shown in FIG. 2.

Examples of the support made from a plastic resin film include transparent or opaque films made from materials including polyester-based films, such as polyester film; diacetate-based films; triacetate-based films, such as cellulose triacetate film; polyolefin-based films, such as polypropylene film; acrylic films; polycarbonate-based films; poly(vinyl chloride)-based films, such as poly(vinyl chloride) film; polyimide-based films; polystyrene film; cellophane; celluloid; and the like, and supports prepared by laminating any of the above-recited films. Preferably, the plastic resin film of which opacity is 70% or more may be used in order to sufficiently exert the advantageous effect of the present invention.

More preferably, so-called RC paper, that is a resin-coated paper (support 2) in which both sides of the paper 2a being coated with resin layers 2b, 2c made from a plastic resin film as shown in FIG. 11 is used as the non-water-absorbing support, and a support prepared by coating the both sides of a paper with polyolefin resin layers is particularly preferable. The manufacturing methods for the support prepared by coating the both sides of a paper with a plastic resin are disclosed in JP-Tokukaisyo-53-117, U.S. Pat. No. 3,449,257B, U.S. Pat. No. 3,558,316B, JP-Tokukaihei-11-295852, JP-Tokukai-2002-351023, and so on.

Hereinafter, a particularly preferable non-water-absorbing support, namely the support 2 prepared by coating both sides of the paper 2a with resin layers comprising polyolefin resin will be explained.

The paper 2a used for the support 2 is prepared by using wood pulp as the main material and additionally a synthetic pulp, such as polypropylene, or a synthetic fiber, such as nylon and polyester, upon requirement. Any of LBKP, LBSP, NBKP, NBSP, LDP, NDP, LUKP, and NUKP may be used as the wood pulp, however, it is preferable to use a wood pulp in which the portion for short fibers is greater, such as LBKP, NBSP, LBSP, NDP and LDP, rather than the others. Note that the ratio of LBSP and/or LDP contained in the paper is preferably in a range of from 10 to 70%, respectively. For the synthetic pulp, a chemical pulp, e.g., a sulfate pulp or a sulfite pulp, containing less impurity, is preferably used, and a pulp of which degree of whiteness being improved by a bleaching treatment is also advantageous to use.

Into the paper, for example, a sizing agent, such as a higher fatty acid and alkyl ketene dimer; a white pigment, such as calcium carbonate, talc and titanium dioxide; a paper-strengthening agent, such as starch, polyacrylamide and poly(vinyl alcohol); a fluorescent brightener; a moisture-maintaining agent, such as polyethylene glycol; a dispersant; a softening agent, such as a quaternary ammonium salt; and the like may be added when appropriate.

The water filtration degree of the pulp to be used for producing the papers is preferably in a range from 200 to 500 ml in accordance with JIS code P8121-1995, and the fiber length of the pulp after beating expressed as the sum of the 24 mesh and 42 mesh residues that is defined in JIS code P 8207 is preferably in a range from 30 to 70%. Note that the rate of 4 mesh residue is preferably 20% or less.

The basis weight of the paper is preferably in a range from 50 to 250 g, and particularly preferable in a range from 70 to 200 g. The thickness of the paper is preferably in a range from 50 to 210 μm.

The paper may be subjected to the calendering process during or following to the manufacturing of the paper to thereby provide the paper with high smoothness. The density of the paper is normally in a range from 0.7 to 1.2 g/m² (in accordance with JIS code P 8118). Further, the rigidity of the material paper is preferably in a range from 20 to 200 g under the condition defined in JIS code P 8143.

The surface of the paper may be applied with a surface sizing agent. In this purpose, sizing agents similar to those added into the material paper as described above may be used.

The pH of the paper is preferably in a range from 5 to 9, when it is measured according to the hot water extraction method defined in JIS code P 8113.

For the polyolefin resin used for the resin layers 2b and 2c of the support 2, polyethylene, polypropylene, polyisobutylene and polyethylene may be used. However, the polyolefin resin is preferably a copolymer comprising propylene as the main component or the like, and is in particular preferably polyethylene.

An explanation of the particularly preferable polyethylene will be made below.

The polyethylene used for coating both front and back surfaces of the paper 2a is mainly low density polyethylene (LDPE) and/or high density polyethylene (HDPE). However, some of the other materials, such as LLDPE and polypropylene, may also be used for the coating of the paper.

In particular, the resin layer 2b positioned at the porous layer 3 side is preferably added therein with titanium dioxide of the rutile or anatase type so that the opacity and whiteness degree of the resin layer is improved. The content of the titanium dioxide is approximately in a range from 1 to 20%, and preferably in a range from 2 to 15%, relative to the polyolefin.

The support 2 according to this embodiment may be provided with a property of giving a predetermined response to specific light in the resin layer 2b positioned at the porous layer 3 side. For example, the resin layer 2b may be incorporated with an ultraviolet absorbing agent or a fluorescent agent as an absorbing agent for non-visible light.

Examples of the ultraviolet absorbing agent and fluorescent agent will now be recited specifically hereinafter, however, it should be noted that, in the present invention, these agents are not limited to those recited in the following.

Examples of the ultraviolet absorbing agent include benzophenone-based compounds, benzotriazole-based compounds, cinnamic-acid-based compounds and the like.

The fluorescent agent includes the ones that generate fluorescence with infrared radiation as the excitation light source, fluorescent brighteners that generate fluorescence with ultraviolet radiation as the excitation light source, and so on. However, it is particularly preferable to use the fluorescent brightener.

The fluorescent brightener is a colorless to pale yellow-colored substance that absorbs light in the near ultraviolet range and emits fluorescence with a color of purplish blue to blue. Examples of the fluorescent brightener include diaminostilbene derivatives, azoles (triazole derivatives, oxazole derivatives, imidazole derivatives, thiazole derivatives and the like), carbazole derivatives, pyridine derivatives, naphthalic acid derivatives, imidazolone derivatives and the like. The fluorescent brightener may be either lipophilic or hydrophilic as far as it can exist in the resin layer, however, the fluorescent brightener is preferably lipophilic because it can be easily added into the resin layer. Specific examples of the fluorescent brightener include dialkylaminocoumarin, bis-dimethylaminostilbene, bis-methylaminostilbene, 4-alkoxy-1,8-naphthalenedicarboxilate-N-alkylimide, bis-benzoxazolyl ethylene, dialkylstilbene and the like.

In addition, a coloring pigment with high thermal resistance may be added appropriately in the resin layer 2b positioned at the porous layer 3 side for the white background adjustment and so on.

Examples of the coloring pigment include ultramarine blue, Prussian blue, cobalt blue, phthalocyanine blue, manganese blue, cerulean, tungsten blue, molybdenum blue, anthraquinone blue and the like.

The amount of polyethylene used for the resin layers 2b, 2c covering the front and back surfaces of the paper 2a is selected so as to optimize the thickness of the porous layer 3 and the curling thereof caused at lowering and raising moisture following to providing the support 2 with a back layer (not shown) at the opposite side to the porous layer 3. The thickness of the polyethylene layer is generally in a range from 15 to 50 μm at the porous layer side and from 10 to 40 μm at the back layer side. The rate of the polyethylene to be contained in the resin layers 2b, 2c at the front and back sides of the paper is preferably fixed so as to adjust the curling that varies depending on the type and thickness of the porous layer 3, the thickness of the paper 2a and so on. In general, the rate of polyethylene in the thickness in the front and back surfaces of the paper 2a is approximately in a range from 3/1 to 1/3.

Further, the support 2 in which the paper 2a has been coated with the resin layers 2b, 2c comprising polyethylene preferably has the following characteristics (1) through (8).

(1) The tensile strength based on the strength as defined in JIS code P 8113 is preferably in a range from 19.6 to 294N in the longitudinal direction and from 9.8 to 196N in the horizontal direction.

(2) The tear strength based on the strength as defined in JIS code P 8116 is preferably in a range from 0.20 to 2.94N in the longitudinal direction and from 0.098 to 2.45N in the horizontal direction.

(3) The compression modulus is preferably not less than 9.8 kN/cm².

(4) The opacity when it is measured in accordance with the method defined in JIS code P 8138 is preferably not less than 80%, and particularly preferably in a range from 85 to 98%.

(5) Regarding the background whiteness, L*, a* and b* each defined in JIS code Z 8727 are preferably L*=80 to 90, a*=−3 to +5, and b*=−7 to +2, respectively.

(6) Regarding the Clark rigidity, the support of which Clark rigidity in the carrying direction of a recording paper being in a range from 50 to 300 cm3/100 is preferably used.

(7) The moisture content in the material paper is preferably in a range from 4 to 10% relative to the paper inside the support 2.

(8) The glossiness (75 degree specular glossiness) for forming the porous layer is preferably in a range from 10 to 90%.

Now, the porous layer 3 to be used for the ink jet recording material 1 will be explained in the following.

The porous layer 3 according to the present invention is formed with an aqueous first coating solution A that contains mainly particulates and a hydrophilic binder.

Inorganic particulates and organic particulates can be used for the particulates to be used in the present invention. However, in particular, since the transparency of the porous layer needs to be higher in order to exert the advantageous effects according to the present invention, inorganic particulates that can provide the ink jet recording material with high smoothness and high coloring density and is readily available is preferably used. For the inorganic particulates, various solid particulates known in the field of the ink jet recording materials can be used.

Examples of the inorganic particulates include white inorganic pigments, such as soft calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudo-boemite, aluminum hydoxide, lithopone, zeolite and magnesium hydroxide, and the like.

The particulates may be used in such a state that they are dispersed in the binder in the form of the primary particulates, or may be added in such a state that they form the secondary cohered-particulates and are dispersed in the binder. However, the later case is more preferable.

There is no constraint in the shape of the inorganic particulates, and they may be shaped in any form of global, rod-shaped, aciform, tabular and bead-shaped. The inorganic particulates preferably have the mean primary particle diameter of from 3 to 200 nm. The use of the particulates of which mean particle diameter being 200 nm or longer results in reductions in the luster of the ink jet recording materials and in the maximum density due to light scattering on the surface of the materials, thus making it difficult to attain sharp images. Although there is no particular limitation in the lower threshold of the mean particle diameter, the lower threshold is, preferably, approximately 3 nm or more in view of the manufacturing of the inorganic particulates. The particularly preferred mean particle diameter of the inorganic particulates in the primary form is in a range from 3 to 100 nm. The mean particle diameter of the particulates is determined by observing the cross sections and surfaces of the particulates themselves or the void layers by means of an electron microscope, then determining the particle diameters of a number of the arbitrary particles to work out their mean value (the mean value of the number of particles), and using the obtained mean value as the mean particle diameter of the particulates. The particle diameter of the individual particle is expressed herein as a diameter of an assumed circle having the equivalent area to the area of the projected particle.

Note that the inorganic particulates specified in the present invention substantially include composite particulates comprising the inorganic particulates and organic substances (comprising either low-molecular compounds or high-molecular compounds) in a small amount as a substantial inorganic particulates. In this case as well, the particle diameters of particles at the latest stage that are observed during the coating under drying are regarded as the particle diameters of the inorganic particulates. The ratio by mass of the organic particulates and the inorganic particulates in the composite particulates comprising the inorganic particulates and organic substances in a small amount is approximately in a range from 1/100 to 1/4.

The inorganic particulates according to this invention is preferably particulates having a low refractive index like silica, in particular, silica or colloidal silica both synthesized according to the vapor phase method, in view of the low cost and the capability to give high reflective density that allows the ink jet recording material 1 to produce prints with high quality. In addition, for the same purpose, silica prepared by the vapor phase method of which surface being coated with cations, colloidal silica of which surface being coated with cations, alumina, colloidal alumina, pseudo-boemite and the like are also usable. This silica synthesized according to the vapor phase method may be the one of which surface being processed with Al.

There is no limitation for the hydrophilic binder to be contained in the porous layer 3, and conventionally known hydrophilic binders can be used. Examples of the hydrophilic binder include aqueous polymers, such as gelatin, poly(vinylpyrrolidone), poly(ethylene oxide), polyacrylamide, and poly(vinyl alcohol), and water-dispersible latexes. However, among the above-recited examples, poly(vinyl alcohol) is particularly preferable.

Poly(vinyl alcohol) is a polymer interacting with the inorganic particulates, and accordingly having particularly high effect of holding the inorganic particulates and further having a hygroscopicity that is relatively less independent on humidity. With such properties, the shrinkage stress of poly(vinyl alcohol) at the time of coating and drying is relatively small. As a result, poly(vinyl alcohol) has suitable property in terms of avoiding cracking at the time of coating and drying from occurring. The poly(vinyl alcohol) suitably used in the present invention includes modified poly(vinyl alcohol), such as poly(vinyl alcohol) of which ends being modified with cations, and anion-modified poly(vinyl alcohol) having anionic groups, as well as normal poly(vinyl alcohol) obtainable from the hydrolysis of poly(vinyl acetate).

The ratio of the particulates relative to the hydrophilic binder in the porous layer 3 is preferably in a range from 2 to 20 times by mass. By doubling the foresaid ratio by mass, it is made possible not only to increase the void ratio in the porous layer to thereby give the sufficient volume of the voids but also to prevent the swelling of the excess hydrophilic binder at the time of ink jet recording, which would fill the voids to thereby be a factor to reduce the ink-absorbing rate of the recording material. When the foresaid ratio by mass is made 20 times or more, on the other hand, it makes possible to prevent cracks from being caused easily when the porous layer was coated with a thick film. The particularly preferable ratio of the particulates to the hydrophilic binder is in a range from 2.5 to 12 times, and most preferably from 3 to 10 times.

When the support 2 is coated with the aqueous first coating solution A, it is preferable to carry out, for example, a corona discharge processing or forming of an undercoat layer comprising poly(vinyl alcohol) or gelatin onto the support 2 for aiming at increasing the adhesion strength between the surface of the support 2 and the porous layer 3 to be formed. Further, the ink jet recording material 1 according to this invention needs not to be colored in white, and a colored support may be used. Besides, the overcoat layer will be described later.

The aqueous first coating solution A forming the porous layer 3 may be added with various additives. Examples of such additives include cationic mordants, bridge forming agents, surface active agents (including cationic, nonionic, anionic and amphoteric), white background tone adjusting agents, fluorescent brighteners, mildewproofing agents, viscosity modifiers, organic solvents with low boiling points, organic solvents with high boiling points, latex emulsions, color fading inhibitors, ultraviolet light absorbers, polyvalent metal compounds (aqueous or non-water-soluble), matting agents, silicon oil and the like. Among the above-recited examples, a cationic mordant is preferably used in order to improve the waterresisting and moisture-resisting properties of the recording material after the printing has been done.

The porous layer 3 of the ink jet recording material 1 according to this invention may be composed in the form of monolayer or multi-layer. In the case the multi-layer structure, it is preferable to coat all the layers simultaneously in view of lowering the manufacturing cost.

Besides, the first coating solution A needs to be prepared such that its property to specific light be different from that of a second coating solution B that will be described later. The details of the second coating solution B will be described in the section thereof incorporated hereinafter.

Besides, according to this invention, the transparency of the porous layer needs to be higher in order to achieve the advantageous effects given by this invention. On the other hand, the opacity of the porous layer is preferably not higher than 40% and more preferably not higher than 20% in order to provide the ink jet recording material with high luster and to attain high coloring density.

Note that, as shown in FIG. 2, an undercoat layer 4 that contains substantially no voids between the support 2 and the porous layer 3 functioning as the ink-receiving layer may be provided occasionally to the ink jet recording material 1 to be used in this invention. This undercoat layer 4 is a layer made from a resin to be formed onto the surface of the support 2, for example, in the form of a thin film. The undercoat layer 4 is provided in order to compensate the less adhering property of the porous layer 3 to the support 2 to thereby enhance the adhesion therebetween.

The undercoat layer 4 may have a property to absorb ink to swell. However, if the undercoat layer 4 swells without limitation, small wrinkles or cracks incline to be caused in the images at the time of ink jet recording. Therefore, when a hydrophilic binder that absorbs ink to swell is used, the undercoat layer 4 is preferably formed in a hardened film.

Examples of the hydrophilic binder to be used in the undercoat layer 4 include gelatin and its derivatives, poly(vinyl alcohol) and its derivatives, poly(vinylpyrrolidone), polyethylene glycol, carboxymethyl cellulose, hydroxycellulose, dextran, dextrin, poly(acrylic acid) and its salts, agar, carrageenan, locust bean gum, gum arabic, pllulan, poly(alkylene oxide)-based copolymeric polymers, aqueous poly(vinyl butylal), polymers such as copolymers each having vinyl monomer containing carboxyl and sulfone groups in the single form or as a repeating unit, and the like. The hydrophilic binder as exampled above may be used alone or in combination of two or more thereof.

Among the above-recited hydrophilic binders, the preferred are gelatin or the derivatives thereof, and poly(vinyl alcohol) or the derivatives thereof. As the gelatin, both gelatins treated with an acid and an alkali can be used. The gelatin derivative preferably used is, for example, a gelatin derivative prepared by treating gelatin with an acid anhydride, such as phthalic anhydride, or isocyanate, such as phenyl isocyanate, to block amino groups in the gelatin.

The amount of the hydrophilic binder to be provided to the undercoat layer 4 is preferably in a range from 0.1 to 10 g per m² of the ink jet recording material. If the amount to be provided exceeds 10 g, cracks and wrinkles may be caused easily in the printed area.

Besides, a film-hardening agent that can react with the hydrophilic binder may be incorporated in the undercoat layer 4. As the film-hardening agent capable of reacting with the hydrophilic binder, compounds capable of reacting with hydroxy and amino groups contained in the hydrophilic binder may be used. Examples of the film-hardening agent include inorganic compounds, such as chromium compounds, aluminum compounds and boric acid, organic film-hardening agents containing epoxy, ethyleneimino, vinyl sulfone, aulyloyl and formyl groups, and the like.

Although the amount of the film-hardening agent to be used differs depending on the types thereof, it is generally in a range from 1 to 200 mg, and preferably from 5 to 100 mg relative to 1 g of a crosslinking hydrophilic polymer.

Besides, the undercoat layer 4 may be provided therein with a property indicating a predetermined response to specific light. For example, the undercoat layer 4 may contain an ultraviolet light absorber and/or a fluorescent agent as an absorbing agent for non-visible light. Description on the details of the ultraviolet light absorber and fluorescent agent is omitted here because it will be the same as the above description with respect to the resin layer 2b positioned at the porous layer 3 side in the support 2.

Note that, when the undercoat layer 4 is provided, the ultraviolet light absorber and fluorescent agent may be contained only in the resin layer 2b positioned at the porous layer 3 side in the support 2, or only in the undercoat layer 4, or in both of the resin layer 2b and the undercoat layer 4.

Next, the second coating solution B that is a solution containing an additive for overcoating (provided to the porous layer 3) will be explained in the following.

The above-described additive contained in the solution used for the overcoating may be applied to various compounds including a compound that can be added into the first coating solution A, a compound inclines to increase the formation of cracking at the time of drying, a compound that causes cohesion when it is added into the first coating solution A and increases or lowers greatly the viscosity of the first coating solution A, and a compound with which it is hard to obtain effective actions due to the reaction in the coated film with moisture or other additives when the compound is added into the first coating solution A. For example, the additive may be applied to organic or inorganic acids, various alkaline additives, aqueous salts of water-soluble multivalent metal ions, various surface active agents of anionic, cationic, amphoteric or nonionic, color fading inhibitors, cationic adhesion promoters, crosslinking agents for hydrophilic binders and the like, pHs of which are altered by using the additive.

The pH on the surface of the porous coated-film is selected so as to be the optimum in various viewpoints. Since the pH on the surface of the film has influence on ink-absorbing property, light-resistance, water resistance, fading-by-gas property, white background change, and dot diameter, the optimum pH is selected with taking the combination with the printer and ink to be used into consideration. However, as described above, there is a constraint for the setting up of the pH of a coating solution in view of the cohesion and viscosity of the coating solution when the coating solution for forming a porous coated-film is prepared. Hence, it is difficult to satisfactorily adjust the pH of the coating solution to the pH on the surface of the film. However, with the overcoating method, it is possible to control the pH on the surface of the film in the recording material independently from the pH of the coating solution.

The acids usable for aiming at reducing the pH on the surface of the porous coated-film include, for example, inorganic acids, such as sulfuric acid, hydrochloric acid, nitric acid and phosphoric acid, and organic acids, such as citric acid, formic acid, acetic acid, phthalic acid, succinic acid, oxalic acid and polyacrylic acid. The pH of a solution of the foresaid acid is preferably in a range from 0 to 6, and particularly preferable from 1 to 5. Further, the pH on the surface of the finished coated-film after completing the pH adjustment is preferably in a range from 3 to 7, and particularly preferable from 3.5 to 6.

Besides, the alkali to be used for aiming at increasing the pH on the surface of the porous coated-film include, for example, sodium hydroxide, potassium hydroxide, sodium carbonate, potassium carbonate, borax, sodium phosphate, calcium hydroxide and organic amine. The pH of a solution of the foresaid alkali is in a range from 8 to 14, and the pH of a solution containing the additives being in a range from 9 to 12 is particularly preferable.

The pH on the surface of the porous layer 3 in the ink jet recording material 1 differs depending on the types of ink. In general, the water resistance and blurs of a dye incline to be improved at the more acidic side and the light resistance inclines to be improved at the higher pH side. Hence, the optimum pH on the surface of the porous coated-film is selected by taking the combination with ink into consideration. The preferred pH on the surface of the porous layer is in a range from 3 to 7, and the particularly preferred is from 3.5 to 6.5. The “PH on the film surface” used herein denotes a value measured according to the measuring method for paper surface defined in J. TAPPI 49. Specifically, the pH on the surface of the coated-film described herein denotes a pH value obtained by dropping 50 μl of pure water (pH=6.2-7.3) onto the surface of a recording material and then measuring pH with a commercially-available planar electrode.

According to one preferred embodiment, a crosslinking agent for the hydrophilic binder is contained in the additive-containing solution used for the overcoating.

Examples of the crosslinking agent usable in this invention include the crosslinking agents described above.

According to one preferred embodiment for this invention, when the aqueous coating solution for forming the porous coated-film contains a crosslinking agent for a hydrophilic binder in advance and the solution containing additives for overcoating further contains a crosslinking agent, the crosslinking activity of the hydrophilic binder is enhanced remarkably to greatly improve the ink absorbing performance. In this embodiment, it is assumed that the apparent molecular weight of the hydrophilic binder is increased resulting from the prior addition of the crosslinking agent to the aqueous coating solution for forming the porous layer, and that the coated-film resistant to swell is formed resulting from providing the crosslinking agent to the additive-containing solution under the condition that the aqueous coating solution has been in the coated-film state.

The crosslinking agent used for the additive-containing solution for overcoating may be same as or different from the crosslinking agent to be contained in the aqueous coating solution. The crosslinking agent used for the overcoating is used in an amount ranging from 1 to 100% by mass, and preferably from 5 to 50% by mass relative to the mass of the hydrophilic binder in the porous layer at the final stage of drying. The particularly preferred crosslinking agent includes borates, a zirconium salt, an aluminum salt or an epoxy-based crosslinking agent.

In one preferred embodiment, the additive-containing solution for the overcoating also functions as an image stabilizer (hereinafter referred to as a color fading inhibitor).

In this invention, a color fading inhibitor conventionally known in the field of ink jet can be used. The color fading inhibitor inhibits fading due to light irradiation and fading caused by various oxidative gases, such as active oxygen, NOx, and SOx. Examples of the color fading inhibitors include antioxidants disclosed in JP-Tokukaisyou-57-74192, JP-Tokukaisyou-57-87989 and JP-Tokukaisyou-60-72785, ultraviolet light absorbing agents disclosed in JP-Tokukaisyou-57-74193, hydrazides disclosed in JP-Tokukaisyou-61-154989, hindered-amine-based antioxidants disclosed in JP-Tokukaisyou-61-146591, nitrogen-containing heterocyclic-mercapto-based compounds disclosed in JP-Tokukaisyou-61-177279, thioether-based antioxidants disclosed in JP-Tokukaihei-1-115677 and JP-Tokukaihei-1-36479, hindered-phenol-based antioxidants having specific structures disclosed in JP-Tokukaihei-1-36480, ascorbic acid and the like disclosed in JP-Tokukaihei-7-195824 and JP-Tokukaihei-8-150773, zinc sulfate disclosed in JP-Tokukaihei-7-149037, thiocyanates disclosed in JP-Tokukaihei-7-314882, thiourea derivatives disclosed in JP-Tokukaihei-7-314883, sugars disclosed in JP-Tokukaihei-7-276790 and JP-Tokukaihei-8-108617, phosphoric-acid-based antioxidants disclosed in JP-Tokukaihei-No. 8-118791, nitrites, sulfites and thiosulfites disclosed in JP-Tokukaihei-8-300807, and hydroxylamine derivatives disclosed in JP-Tokukaihei-9-267-544. Furthermore, polymers and condensates of dicyandiamide and polyalkylene polyamine disclosed in JP-Tokukai-2000-263928 are also useful color fading inhibitors in the ink jet recording system. Though the color fading inhibitor may be added into the coating solution for forming the porous coated-film, it is preferable in this invention to use the overcoating method because the fading inhibitor in a greater amount may be added with this method in order to inhibit the increase in the cohesion and cracks of the coating solution.

The amount of the fading inhibitor to be added is in a range from 0.01 to 5 g, and preferably from 0.1 to 2 g per m² of the recording material. The fading-inhibiting activity becomes greater with the increase in the amount of the fading inhibitor to be added. However, since the void volume is reduced with the increase in the amount of the fading inhibitor, there is naturally a limitation in the amount to be added.

A cationic polymer may be contained in the additive-containing solution. The cationic polymer acts as a fixer of a dye in general, and it is preferable to add the cationic polymer in advance in the coating solution for forming the porous layer in order to provide water resistance and to prevent blurs from occurring. In the case any problem happens when the cationic polymer is added into the coating solution, the cationic polymer may be provided by means of the overcoating method. For example, in the case that the viscosity of the coating solution is increased with time passage, or that the distribution of the cationic polymer in the porous layer is formed to improve the coloring effect, the cationic polymer is preferably added by means of the overcoating method. When the cationic polymer is provided according to the overcoating method, the amount thereof is in a range from 0.1 to 5 g per m² of the recording material.

In another preferred example, the additive-containing solution for the overcoating contains an aqueous multivalent metal compound as the additive.

The aqueous multivalent metal compound tends to cause cohesion by itself in many cases when it exists in the coating solution containing inorganic particles. As a result, the aqueous multivalent metal compound causes the microscopic coating defect and reduction in the luster. Hence, the aqueous multivalent metal compound is preferably provided by means of the overcoating method.

For the multivalent metal compound, a sulfate, a chloride, a nitrate, a acetate, etc. of Mg²⁺, Ca²⁺, Zn²⁺, Zr²⁺, Ni²⁺ or Al³⁺ is used. Note that inorganic polymer compounds, such as poly(aluminum hydroxide) and zirconyl acetate, are included in the preferred aqueous multivalent metal compound. In general, many of these aqueous compounds have function to improve light resistance, to prevent blurs from occurring and to improve water resistance. These aqueous multivalent metal ions are used in an amount ranging from 0.05 to 20 mmol, and preferably from 0.1 to 10 mmol, relative to m² of the recording material.

In another embodiment, the additive-containing solution to be overcoated contains a surface active agent.

A surface active agent can be used to control the dot diameter at the time of ink jet recording. Such a surface active agent is an anionic, cationic, amphoteric or nonionic surface active agent. Further, two or more surface active agents may be used in combination. The amount of the surface active agent to be used is in a range from 0.01 to 50 mg per m² of the recording material. If the amount exceeds 50 mg, cloudy spots tends to be caused at the time of ink jet recording.

Various additives other than the above-described ones may be added into the additive-containing solution. Examples of such additives include a dye for adjusting the tone of the white background, a mildewproofing agent, a water-soluble polymer, a plasticizer (e.g., glycerin and diethylene glycol) and the like.

Each of the additives described hereinabove may be used alone, or two or more thereof may be used in combination. Specifically, a solution containing two or more fading inhibitors, a solution containing a fading inhibitor and a crosslinking agent, and a solution containing a fading inhibitor and a surface active agent may be used. Further, a crosslinking agent, a water-soluble multivalent metal compound and a fading inhibitor may be used in combination.

In this invention, a solvent for the additive-containing solution is preferably water or a mixed solution of water-compatible organic solvent and water, and water is particularly preferable. Also, a mixed solvent of water and a water-compatible organic solvent with a low boiling point (e.g., methanol, ethanol, i-propanol, n-propanol, acetone, methyl ethyl ketone, etc.) are preferably used for the same purpose. When water and a water-compatible organic solvent are used in combination, the content of water is preferably 50% by mass or more relative to the mass of the whole solvent.

The organic solvent with a low boiling point denotes an organic solvent having solubility to water of 10% by mass or more at room temperature and a boiling point of 120° C. or below.

Besides, the second coating solution B has function, in addition to the above-described function, to alter the property of the recording material to response to specific light.

Hereinafter, the case that the second coating solution B has function to alter the property of the recording material to specific light from the property where only the first coating solution A is coated thereto will be explained. In other words, the case where the recording material is configured such that the property of the first coating solution to specific light differs from the property of the second coating solution B to specific light will be explained in the following.

Specifically, the following patterns may be exemplified.

Note that, in the first and sixth patterns, the property of the first coating solution A to specific light differs from the property of the second coating solution B to specific light in such a manner that the first coating solution A is made not to contain the additive for varying the property to specific non-visible light, but only the second coating solution B is made to contain the additive for varying the property to specific non-visible light. Contrary thereto, in the other patterns, it is configured such that the property of the first coating solution A to specific light differs from the property of the second coating solution B to specific light in such a manner that not only the second coating solution B but also the first coating solution A are made to contain the additive for varying the property to specific non-visible light.

In the first pattern, it is configured such that the first coating solution A is made not to contain an absorbing agent for non-visible light, for example, ultraviolet radiation, whereas the second coating solution B is made to contain an absorbing agent for ultraviolet radiation, so that the refractive indexes thereof obtainable when these solutions are irradiated with ultraviolet radiation are made different from each other.

In the second pattern, it is configured such that the first coating solution A is made to contain an absorbing agent for non-visible light with a first wavelength, for example, ultraviolet radiation with a first wavelength, whereas the second coating solution B is made to contain an absorbing agent for ultraviolet radiation with a second wavelength different in the wavelength from the ultraviolet radiation with the first wavelength, so that the refractive indexes thereof obtainable when ultraviolet radiations with the first and second wavelengths are respectively irradiated to these solutions are made different from each other.

In the third pattern, it is configured such that the first coating solution A is made to contain a fluorescent agent (a fluorescent brightener)-emitting fluorescence by using specific non-visible light, for example, ultraviolet radiation as the excitation light source, whereas the second coating solution B is made to contain a fluorescent deactivating agent for deactivating the fluorescence, so that the fluorescence strengths emitted from these solutions when ultraviolet radiation is irradiated thereto are made different from each other.

In the fourth pattern, it is configured such that the first coating solution A is made to contain a fluorescent agent (a fluorescent brightener) emitting fluorescence by using specific non-visible light, for example, ultraviolet radiation as the excitation light source, whereas the second coating solution B is made to contain an absorbing agent for ultraviolet radiation, so that the fluorescence strengths emitted from these solutions when ultraviolet radiation is irradiated thereto are made different from each other.

In the fifth pattern, it is configured such that the first coating solution A is made to contain a fluorescent agent (a fluorescent brightener) emitting fluorescence by using specific non-visible light, for example, ultraviolet radiation as an excitation light source, whereas the second coating solution B is made to contain an absorbing agent for light with a wavelength falling within the wavelength of the fluorescence, so that the fluorescence strengths emitted from these solutions when ultraviolet radiation is irradiated thereto are made different from each other.

In the sixth pattern, it is configured such that the first coating solution A is made not to contain a fluorescent agent (a fluorescent brightener) emitting fluorescence by using specific non-visible light, for example, ultraviolet radiation as an excitation light source, whereas the second coating solution B is made to contain a fluorescent agent (a fluorescent brightener) emitting fluorescence by using ultraviolet radiation as an excitation light source, so that the fluorescence strengths emitted from these solutions when ultraviolet radiation is irradiated thereto are made different from each other.

In the seventh pattern, it is configured such that the first coating solution A is made to contain a fluorescent agent (a fluorescent brightener) emitting a first fluorescence by using non-visible light with a first wavelength, for example, ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength, so that the fluorescence strengths emitted from these solutions when the ultraviolet radiations with the first and second wavelengths are respectively irradiated thereto are made different from each other.

In the eighth pattern, it is configured such that the first coating solution A is made to contain a fluorescent agent (a fluorescent brightener) emitting first fluorescence by using non-visible light with a predetermined wavelength, for example, ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent (fluorescent brightener) emitting the first fluorescence by using ultraviolet radiation with the same wavelength as an excitation light source, so that fluorescence with two different wavelengths (two different fluorescent strengths) are emitted from the solutions A and B, respectively, when the ultraviolet radiation with a predetermined wavelength is irradiated thereto.

Now, an example in which the support 2 is provided with a property to give a predetermined response to specific light and the second coating solution B is provided with a property to give a response different from that of the support 2 to specific light will be explained in the following.

Note that, in this case, the first coating solution A and the undercoat layer 4 may not contain the additive for altering the property to specific non-visible light.

Specifically, the recording material may be configured in the following patterns.

In the first pattern, it is configured such that, for example, the resin layer 2b positioning at the porous layer 3 side in the support 2 is made to contain an absorbing agent for non-visible light with a first wavelength, for example, ultraviolet radiation with a first wavelength, whereas the second coating solution B is made to contain an absorbing agent for ultraviolet radiation with a second wavelength different in the wavelength from the ultraviolet radiation with the first wavelength, so that the refractive indexes obtainable when the ultraviolet radiations with the first and second wavelengths are irradiated respectively to the recording material are made different from each other.

In the second pattern, it is configured such that, for example, the resin layer 2b positioning at the porous layer 3 side in the support 2 is made to contain a fluorescent agent (a fluorescent brightener) emitting fluorescence by using specific non-visible light, for example, ultraviolet radiation as an excitation light source, whereas the second coating solution B is made to contain a fluorescent deactivating agent for deactivating the fluorescence, so that the fluorescent strengths from the resin layer and the solution obtainable when ultraviolet radiation is irradiated thereto are made different from each other.

In the third pattern, it is configured such that, for example, the resin layer 2b positioning at the porous layer 3 side in the support 2 is made to contain a fluorescent agent (a fluorescent brightener) emitting fluorescence by using specific non-visible light, for example, ultraviolet radiation as an excitation light source, whereas the second coating solution B is made to contain an absorbing agent for ultraviolet radiation, so that the fluorescent strengths from the resin layer and the solution obtainable when ultraviolet radiation is irradiated thereto are made different from each other.

In the fourth pattern, it is configured such that, for example, the resin layer 2b positioning at the porous layer 3 side in the support 2 is made to contain a fluorescent agent (a fluorescent brightener) emitting fluorescence by using specific non-visible light, for example, ultraviolet radiation as an excitation light source, whereas the second coating solution B is made to contain an absorbing agent for light with a wavelength falling within the wavelength range of the fluorescence, so that the fluorescent strengths from the resin layer and the solution obtainable when ultraviolet radiation is irradiated thereto are made different from each other.

In the fifth pattern, it is configured such that, for example, the resin layer 2b positioning at the porous layer 3 side in the support 2 is made to contain a fluorescent agent (a fluorescent brightener) emitting first fluorescence by using non-visible light with a first wavelength, for example, ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength as an excitation light source, so that the fluorescent strengths from the resin layer and the solution obtainable when the ultraviolet radiations with the first and second wavelengths are irradiated respectively thereto are made different from each other.

In the sixth pattern, it is configured such that, for example, the resin layer 2b positioning at the porous layer 3 side in the support 2 is made to contain a fluorescent agent (a fluorescent brightener) emitting the first fluorescence by using non-visible light with a predetermined wavelength, for example, ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent (fluorescent brightener) emitting the first fluorescence by using ultraviolet radiation with the same wavelength as an excitation light source, so that fluorescence with two different wavelengths (two different fluorescent strengths) are emitted respectively from the resin layer and the solution when the ultraviolet radiation with a predetermined wavelength is irradiated thereto.

Next, the ink jet recording material 1 in which it is configured, as shown in FIG. 2, such that a support 2 is provided with an undercoat layer 4, and a first coating solution A is coated on the undercoat layer 4 so that a porous layer 3 is formed on the support 2 via the undercoat layer 4, wherein the undercoat layer 4 is provided with a property to give a predetermined response to specific light and a second coating solution B is provided with a property to give a response different from the response of the undercoat layer 4 to specific light will be explained in the following.

Note that, in this case, the first coating solution A and the support 2 may not contain the additive for altering the property to specific non-visible light.

Specifically, the recording material may be configured in the following patterns.

In the first pattern, it is configured such that the undercoat layer 4 is made to contain an absorbing agent for non-visible light with a first wavelength, for example, ultraviolet radiation with a first wavelength, whereas the second coating solution B is made to contain an absorbing agent for ultraviolet radiation with a second wavelength different in the wavelength from the ultraviolet radiation with the first wavelength, so that the refractive indexes of the undercoat layer and the solution obtainable when the ultraviolet radiations with the first and second wavelengths are irradiated respectively thereto are made different from each other.

In the second pattern, it is configured such that the undercoat layer 4 is made to contain a fluorescent agent (a fluorescent brightener) emitting fluorescence by using specific non-visible light, for example, ultraviolet radiation as an excitation light source, whereas the second coating solution B is made to contain a fluorescent deactivating agent for deactivating the fluorescence, so that the fluorescent strengths from the undercoat layer and the solution obtainable when the ultraviolet radiation is irradiated thereto are made different from each other.

In the third pattern, it is configured such that the undercoat layer 4 is made to contain a fluorescent agent (a fluorescent brightener) emitting fluorescence by using specific non-visible light, for example, ultraviolet radiation as an excitation light source, whereas the second coating solution B is made to contain an absorbing agent for ultraviolet radiation, so that the fluorescent strengths from the undercoat layer and the solution obtainable when ultraviolet radiation is irradiated thereto are made different from each other.

In the fourth pattern, it is configured such that the undercoat layer 4 is made to contain a fluorescent agent (a fluorescent brightener) emitting fluorescence by using specific non-visible light, for example, ultraviolet radiation as an excitation light source, whereas the second coating solution B is made to contain an absorbing agent for light with a wavelength falling within the wavelength range of the fluorescence, so that the fluorescent strengths from the undercoat layer and the solution obtainable when ultraviolet radiation is irradiated thereto are made different from each other.

In the fifth pattern, it is configured such that the undercoat layer 4 is made to contain a fluorescent agent (a fluorescent brightener) emitting first fluorescence by using non-visible light with a first wavelength, for example, ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength as an excitation light source, so that the fluorescent strengths from the undercoat layer and the solution obtainable when the ultraviolet radiations with the first and second wavelengths are irradiated respectively thereto are made different from each other.

In the sixth pattern, it is configured such that the undercoat layer 4 is made to contain a fluorescent agent (a fluorescent brightener) emitting first fluorescence by using non-visible light with a predetermined wavelength, for example, ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent (fluorescent brightener) emitting the first fluorescence by using ultraviolet radiation with the same wavelength as an excitation light source, so that fluorescence with two different wavelengths (two different fluorescent strengths) are emitted respectively from the undercoat layer and the solution when the ultraviolet radiation with a predetermined wavelength is irradiated thereto.

Note that, in this embodiment, it is configured such that, when the additives, such as the ultraviolet light absorber and fluorescent agent, for altering the property to specific non-visible light (ultraviolet radiation in this embodiment) are made contained in any of the first coating solution A forming the porous layer 3, the support 2 and the undercoat layer 4, the additives, such as the ultraviolet light absorber and fluorescent agent, are not contained in the other layers. However, the present invention is not limited to such a configuration. Accordingly, the additives used for altering the property to specific non-visible light may be contained in two layers of the first coating solution A and the support 2, in two layers of the first coating solution A and the undercoat layer 4, in two layers of the support 2 and the undercoat layer 4, and in all of three layers of the first coating solution A, the undercoat layer 4 and the support 2.

Now, a method for providing and drying the above-described solution containing respective additives will be explained hereinbelow.

As described above, in the present invention, the providing (overcoating) of the solution containing the respective additives is performed after the completion of drying the coated porous layer.

The timing for performing the preparation of the solution containing the respective additives is within an hour, preferably within 15 min, and further preferably within five min after the completion of drying the coated porous layer.

The finish point of the drying is a point of time at which the temperature of the coated porous layer comes to the equal level to the temperature of the drying air flow. If the solution containing the respective additives is provided prior to the finish point of the drying, cloudy spots incline to occur especially at the time of printing by means of a high-speed printer. It is assumed that this defect of causing cloudy spots is due to the fact that the speed of absorbing the additive-containing solution is reduced in response to the swelling of the binder in the coated layer, which is caused by moisture remaining in the coated porous layer before the finish point of the drying, whereby causing unevenness in the distribution of the additives in the coated layer. Therefore, it is preferable to provide the additives not shorter than five sec after the finish point of the drying. Note that it is preferable to provide the additive-containing solution to the porous layer within 15 min, preferably within five min, and more preferably within 30 sec following to the finish point of the drying.

Besides, the temperature of the coated porous layer at the time of providing the additive-containing aqueous solution is preferably in a range from 25 to 70° C. By controlling the temperature of the coated porous layer at 25° C. or higher, the reduction in the absorbing rate of the additive-containing solution and accordingly the forming of the cloudy spots are prevented from occurring, and by controlling the temperature at 70° C. or lower, the forming of uneven surface of the coated porous layer caused by too fast evaporation of the additive-containing solution is prevented from occurring. Therefore, the preferred temperature of the coated porous layer is in a range from 30 to 65° C.

The amount of the additive-containing aqueous solution to be applied is preferably equal to or less than the void volume included in the coated porous layer. The void volume denotes a transformed amount of liquid during the contacting period of time of two sec when the recording material is measured according to the liquid absorption test method (Bristow method) for papers and paperboards defined in J. TAPPI 51.

By controlling the supply amount of the additive-containing solution to an amount equal to or less than the void volume, it is possible to prevent the forming of the unevenness in the absorbency of the produced recording material and cloudy spots resulting from the unevenness from occurring. Besides, immediately after the drying, the coated porous layer is still in relatively-high swelling state and has no sufficient absorbency. Therefore, the amount of the additive-containing solution to be applied is preferable 80% or less of the void volume. The lower threshold of the amount of the additive-containing solution to be applied depends on the applying amount and solubility of the additives and the applying method, but the lower threshold is 2 ml or more per m² of the recording material.

The method for coating the additive-containing solution may be selected appropriately from known coating methods. Specifically, though the method described above in the section of the coating of the porous layer may be used, the particularly preferred is a method to spray the solution in the form of droplets as described in JP-Tokukai-2004-906, where the solution is applied by means of a slot nozzle spray apparatus provided with a plurality of micro nozzles for ejecting gas being arranged over the applying width.

Preferably, the coating of the additive-containing solution is carried out at a temperature of 60° C. or lower.

The additive-containing solution is preferably filtered prior to performing the coating, especially using the slot nozzle spray apparatus equipped with gas nozzles as the coating means, because fine foreign articles and dirt may clog the nozzles, which will be the cause of striped coating. Generally, a filter capable of removing particles being in a size ranging from about 5 to 20 μm is preferably used.

After coating a solvent, the recording material is preferably dried and then rolled. According to this invention, at this stage, the recording material is preferably rolled in the state that 50% or more of the solvent applied by overcoating method has been dried.

In the case that the recording material is rolled in the state that 50% or more of the applied solvent having been dried, curling of the recording material after cutting can be made less and occurrence of the surface unevenness appearing during the storage in the rolled state can be prevented. As a result, the defect of striped coating can be reduced. The applied solvent is preferably dried until the weight thereof becomes one third or less of the applied weight, and it is particularly preferable to dry the solvent until the solvent has reached in an equilibrium state with the surrounding atmosphere.

The recording material according to this invention is used for the ink jet recording where a material mainly containing acidic dyes is used. However, the inventive recording material can also be used for the ink jet recordings where aqueous and oily pigment inks are used.

Next, one exemplary embodiment for producing the ink jet recording material according to this invention, in particular, with regard to the performance inspection process of the ink jet recording material will be explained with reference to FIGS. 1 to 7.

In this embodiment, a resin-made coated paper prepared by coating the both surfaces of a paper 2a with resin layers 2b, 2c made from a polyolefin resin as shown in FIG. 1 is used as the support 2. On the way that the support 2 reeled out from the original roll of the support 2 by means of a conveying section (not shown) passes through a support roller 30 and is then carried in the reverse direction at the position of a backup roller 20, a first coating solution A supplied from a slide bead coating apparatus 10 of the flow-rate-controlled type is coated onto the support 2. Alternatively, as shown in FIG. 2, it may be configured such that an undercoat layer 4 is provided on one side of the support 2, and the first coating solution A is coated onto the undercoat layer 4. Hereinafter, the support 2 having been in the above-described state (including the support 2 having the undercoat layer thereon) is referred to as a base body 5.

Since the first coating solution A contains a hydrophilic binder, it is once cooled at a cooling zone 40 to be solidified. The base body 5 having a porous layer 3 on the support 2 is then carried into the drying process.

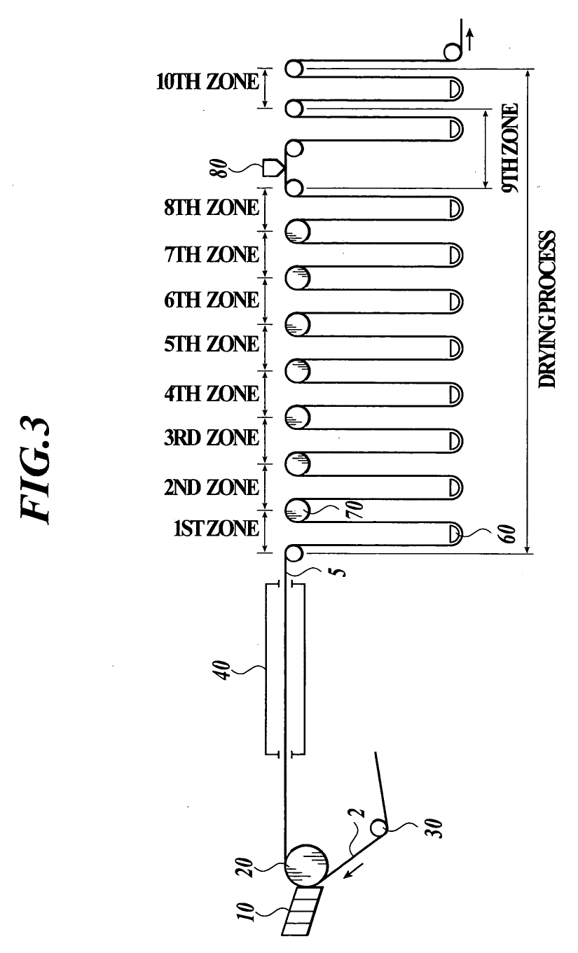

In the drying process, reversers 60 adapted to blow out air to convey the base body in the reverse direction in the state with no contact with the surface of the coated layer and common conveying rollers 70 adapted to contact with the reverse side of the base body 5 to convey the base body in the reverse direction are alternately arranged so that the base body is conveyed in a meandering manner. In this drying process, a warm air blowing section (not shown) blows warm air against the base body 5 to dry it. In FIG. 3, an example of providing ten drying zones including the first to tenth zones for the drying process is shown. On the way of this drying process, at a position (the vicinity of the ninth zone in FIG. 3) after the finish point of drying (the vicinity of the exit area of the seventh zone in FIG. 3), the coating of the additive-containing solution (the second coating solution B) in the form of droplets is sprayed by a slot nozzle spray apparatus 80 is carried out.

Though one slot nozzle spray apparatus 80 is used in FIG. 3, a plurality of the apparatus may be used upon necessity. It is preferable to perform the spraying with the droplets in a multi-stage manner so that the load to the coated layer at drying is reduced and the uniformity of the coated layer is improved.

The coating rate at applying the additive-containing solution onto the porous layer may be altered depending on the type, concentration and solvent content of the coating solution, drying performance, etc., however, the coating rate is preferably in a range from 50 to 300 m/min, and more preferably from 100 to 300 m/min.

Besides, as shown in FIG. 3, the coating process for forming the porous layer 3 and the process for applying the additive-containing solution onto the porous layer are preferably performed in series on the same production line. The process for applying the additive-containing solution onto the porous layer may be performed in the drying process for drying the porous layer as shown in FIG. 3. In the drying process, it is preferable to blow dried-air being controlled at a specific temperature and humidity to the front and back surfaces of the coated layer to dry it while continuously conveying the coated layer being in a wetting state.

After the drying process, the performance of the formed ink jet recording material 1 is inspected. Concretely, whether the second coating solution B is uniformly coated or not is inspected. As described above, since the ink jet recording material 1 according to this invention is configured such that the property to specific light is altered with the coating of the second coating solution B onto the material, the inspection as to whether the uniform coating of the second coating solution B is performed by passing the recording material through an inspection apparatus that utilizes such a property to specific light.

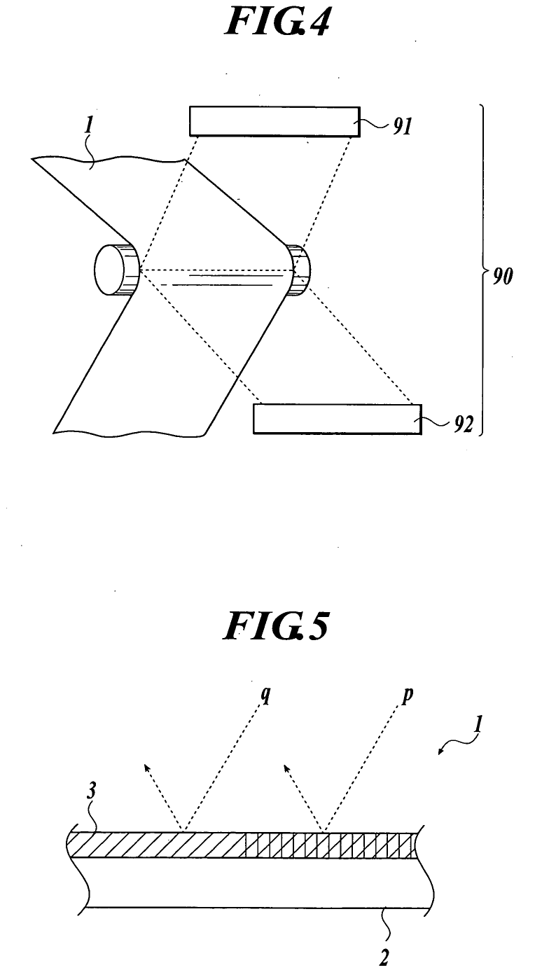

As shown in FIG. 4, the inspection apparatus 90 includes an irradiation device 91 for irradiating predetermined light, ultraviolet radiation in this case, in lines to the ink jet recording material 1 toward the width direction, and a reading device 92 for reading the response of the ink jet recording material 1 to the irradiating ultraviolet radiation.

Hereinbelow, an example in which it is configured such that the properties to ultraviolet radiation of the first coating solution A and the second coating solution B are made different from each other will be explained.

Specifically, the following patterns can be configured for this example.

Note that, in the first and sixth patterns, it is configured such that the first coating solution A is made not to contain an additive that alters the property to ultraviolet radiation, and the additive for altering the property to ultraviolet radiation is contained only in the second coating solution B, so that the properties to ultraviolet radiation of the first and second coating solutions A and B are made different from each other. Differently therefrom, in the other patterns, it is configured such that not only the second coating solution B but also the first coating solution A are made to contain the additive for altering the property to ultraviolet radiation, so that the properties to ultraviolet radiation of the first and second coating solutions A and B are made different from each other.

In the first pattern, when the first coating solution A is made not to contain an absorbing agent for ultraviolet radiation, whereas the second coating solution is made to contain an absorbing agent for ultraviolet radiation, the reflectance obtainable when ultraviolet radiation is irradiated to the recording material is measured by means of the reading device 92. Whereupon, as shown in FIG. 1, a measured result indicating a low reflectance for ultraviolet radiation is detected in the whole area to which the two coating solutions are coated, when the second coating solution B is coated uniformly. On the other hand, when the second coating solution B is coated but not uniformly as shown in FIG. 5, a measured result indicating a low reflectance for ultraviolet radiation is detected in the area whereto the second coating solution B is coated (the area whereto ultraviolet radiation p is irradiated), whereas a measured result indicating a high reflectance for ultraviolet radiation is detected in the area whereto the second coating solution B is not coated (i.e., the area whereto ultraviolet radiation q is irradiated).

In the second pattern, when the first coating solution A is made to contain an absorbing agent for ultraviolet radiation with a first wavelength, whereas the second coating solution B is made to contain an absorbing agent for ultraviolet radiation with a second wavelength different in the wavelength from the ultraviolet radiation with the first wavelength, the reflectances obtainable when the ultraviolet radiations with the first and second wavelengths are irradiated respectively to the recording material are measured by the reading device 92. Whereupon, when both of the first and second coating solutions A and B are coated uniformly as shown in FIG. 1, such a measured result indicating that both reflectances for the ultraviolet radiations with the first and second wavelengths be low is detected in the whole area to which the two coating solutions are coated. On the other hand, when the second coating solution B is coated but not uniformly as shown in FIG. 5, such a measured result indicating that both reflectances for the ultraviolet radiations with the first and second wavelengths be low is detected in the area whereto the first and second coating solutions A and B are coated (i.e., the area whereto ultraviolet radiation p is irradiated), whereas such a measured result indicating that the reflectance for the ultraviolet radiation with the first wavelength be low and the reflectance for the ultraviolet radiation with the second wavelength be high is detected in the area whereto the second coating solution B is not coated (i.e., the area whereto ultraviolet radiation q is irradiated). Further, when the first coating solution A is coated but not uniformly, a measured result indicating a high reflectance for the ultraviolet radiation with the first wavelength is detected in the area whereto the first coating solution A is not coated.

In the third pattern, when the first coating solution A is made to contain a fluorescent agent (a fluorescent brightener) emitting fluorescence by using ultraviolet radiation as an excitation light source, whereas the second coating solution B is made to contain a fluorescent deactivating agent for deactivating the fluorescence, the fluorescent strength obtainable when ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two solutions are coated. On the other hand, when the second coating solution B is coated but not uniformly as shown in FIG. 5, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the fourth pattern, when the first coating solution A is made to contain a fluorescent agent (a fluorescent brightener) emitting fluorescence by using ultraviolet radiation as an excitation light source, whereas the second coating solution B is made to contain an absorbing agent for ultraviolet radiation, the fluorescent strength obtainable when ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two coating solutions are coated. On the other hand, when the second coating solution B is coated but not uniformly as shown in FIG. 5, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the fifth pattern, when the first coating solution A is made to contain a fluorescent agent (a fluorescent brightener) emitting fluorescence by using ultraviolet radiation as an excitation light source, whereas the second coating solution B is made to contain an absorbing agent for light with a wavelength falling within the wavelength range of the fluorescence, the fluorescent strength obtainable when-ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two coating solutions are coated. On the other hand, when the second coating solution B is coated but not uniformly as shown in FIG. 5, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the sixth pattern, when the first coating solution A is made not to contain a fluorescent agent (a fluorescent brightener) emitting fluorescence by using ultraviolet radiation as an excitation light source, whereas the second coating solution B is made to contain a fluorescent agent (a fluorescent brightener) emitting fluorescence by using ultraviolet radiation as an excitation light source, the fluorescent strength obtainable when ultraviolet radiation is irradiated to the recording material is measured by the reading device 92. Whereupon, when the second coating solution B is coated uniformly as shown in FIG. 1, a measured result indicating a certain fluorescent strength is detected in the whole area to which the two coating solutions are coated. On the other hand, when the second coating solution B is coated but not uniformly as shown in FIG. 5, a measured result indicating a certain fluorescent strength is detected in the area whereto the second coating solution B is coated (the area whereto ultraviolet radiation p is irradiated), whereas a measured result indicating a fluorescent strength is not detected in the area whereto the second coating solution B is not coated (the area whereto ultraviolet radiation q is irradiated).

In the seventh pattern, when the first coating solution A is made to contain a fluorescent agent (a fluorescent brightener) emitting first fluorescence by using ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength as an excitation light source, the fluorescent strengths obtainable when the ultraviolet radiations with the first and second wavelengths are irradiated respectively to the recording material are measured respectively by the reading device 92. Whereupon, when both of the first and second coating solutions A and B are coated uniformly as shown in FIG. 1, such a measured result that both of the first and second fluorescence respectively indicate a certain fluorescent strength is detected in the area whereto the two coating solutions are coated. On the other hand, when the second coating solution B is coated but not uniformly as shown in FIG. 5, such a measured result that both of the first and second fluorescence respectively indicate a certain fluorescent strength is detected in the area whereto the first and second coating solutions A and B are coated (the area whereto ultraviolet radiation p is irradiated), whereas such a measured result that the first fluorescence gives a certain fluorescent strength but the second fluorescence gives substantially no fluorescent strength is detected in the area whereto the first coating solution A is coated but the second coating solution B is not coated (the area whereto ultraviolet radiation q id irradiated). Moreover, when the first coating solution A is coated but not uniformly, such a measured result that the first fluorescence gives substantially no fluorescent strength in the area whereto the first coating solution A is not coated is detected.

In the eighth pattern, when the first coating solution A is made to contain a fluorescent agent (a fluorescent brightener) emitting first fluorescence by using ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent emitting the first fluorescence by using ultraviolet radiation with the same wavelength as an excitation light source, fluorescent strengths of the two types obtainable when the ultraviolet radiation with a predetermined wavelength is irradiated to the recording material are measured by two reading devices 92, respectively. Whereupon, when both of the first and second coating solutions A and B are coated uniformly as shown in FIG. 1, a measured result indicating a certain fluorescent strength for the respective wavelengths of the two different types is detected in the whole area whereto the two coating solutions are coated. On the other hand, when the second coating solution B is coated but not uniformly as shown in FIG. 5, a measured result indicating a certain fluorescent strength similar to the above for the respective wavelengths of the two different types is detected in the area whereto the first and second coating solutions A and B are coated (the area whereto ultraviolet radiation p is irradiated), whereas such a measured result that the fluorescent strength for one of the wavelengths of the two different types be different from the above is detected in the area whereto the first coating solution A is coated but the second coating solution B is not coated (the area whereto ultraviolet radiation q is irradiated). Moreover, when the first coating solution A is coated but not uniformly, a measured result indicating substantially no fluorescent strength is detected in the area whereto the first coating solution A is not coated is detected.

Next, another embodiment configured such that the support 2 is provided with a property of giving a predetermined response to specific light, and the second coating solution B is provided with a property of giving a response different from that of the support 2 to specific light will be explained hereinbelow.

Specifically, the patterns recited in the following may be given.

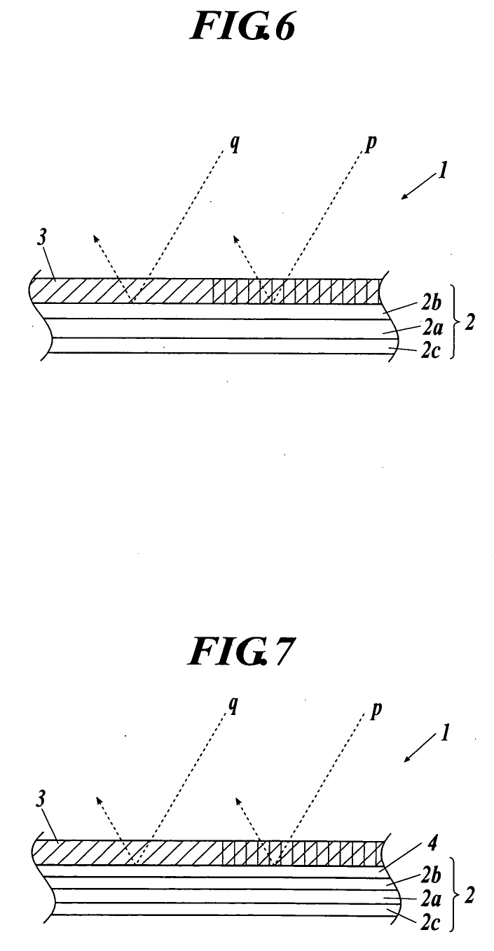

In the first pattern, when the resin layer 2b positioning at the porous layer 3 side in the support 2 is made to contain an absorbing agent for ultraviolet radiation with a first wavelength, whereas the second coating solution B is made to contain an absorbing agent for ultraviolet radiation with a second wavelength different in the wavelength from the ultraviolet radiation with the first wavelength, the reflectances obtainable when the ultraviolet radiations with the first and second wavelengths are irradiated respectively to the recording material are measured by the reading device 92. Whereupon, when the second coating solution B is coated uniformly as shown in FIG. 1, such a measured result that the reflectances for both of the ultraviolet radiations with the first and second wavelengths be low is detected in the whole area whereto the two coating solutions are coated. On the other hand, when the second coating solution B is coated but not uniformly as shown in FIG. 6, such a measured result that the reflectances for both of the ultraviolet radiations with the first and second wavelengths be low are detected in the area whereto the second coating solution B is coated (the area whereto ultraviolet radiation p is irradiated), whereas such a measured result that the reflectance for the ultraviolet radiation with the first wavelength be low and the reflectance for the ultraviolet radiation with the second wavelength be high is detected in the area whereto the second coating solution B is not coated (the area whereto ultraviolet radiation q is irradiated).

In the second pattern, when the resin layer 2b positioning at the porous layer 3 side in the support 2 is made to contain a fluorescent agent (a fluorescent brightener) emitting fluorescence by using ultraviolet radiation as an excitation light source, whereas the second coating solution B is made to contain a fluorescent deactivating agent for deactivating the fluorescence, the fluorescent strength obtainable when ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two coating solutions are coated. On the other hand, when the second coating solution B is coated but not uniformly as shown in FIG. 6, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the third pattern, when the resin layer 2b positioning at the porous layer 3 side in the support 2 is made to contain a fluorescent agent (a fluorescent brightener) emitting fluorescence by using ultraviolet radiation as an excitation light source, whereas the second coating solution B is made to contain an absorbing agent for ultraviolet radiation, the fluorescent strength obtainable when ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two coating solutions are coated. On the other hand, when the second coating solution B is coated but not uniformly as shown in FIG. 6, a measured result indicating a low fluorescent strength is detected in the area whereto the second coating solution B is coated (the area ultraviolet radiation p is irradiated), whereas a measured result indicating a high fluorescent strength is detected in the area whereto the second coating solution B is not coated (the area whereto ultraviolet radiation q is irradiated).

In the fourth pattern, when the resin layer 2b positioning at the porous layer 3 side in the support 2 is made to contain a fluorescent agent (a fluorescent brightener) emitting fluorescence by using ultraviolet radiation as an excitation light source, whereas the second coating solution B is made to contain an absorbing agent for light with a wavelength falling within the wavelength range of the fluorescence, the fluorescent strength obtainable when ultraviolet radiation is irradiated to the recording material is measured by the reading device 92. Whereupon, when the second coating solution B is coated uniformly as shown in FIG. 1, a measured result indicating a certain low fluorescent strength is detected in the whole area to which the two coating solutions are coated. On the other hand, when the second coating solution B is coated but not uniformly as shown in FIG. 6, a measured result indicating a low fluorescent strength is detected in the area whereto the second coating solution B is coated (the area ultraviolet radiation p is irradiated), whereas a measured result indicating a high fluorescent strength is detected in the area whereto the second coating solution B is not coated (the area whereto ultraviolet radiation q is irradiated).

In the fifth pattern, when the resin layer 2b positioning at the porous layer 3 side in the support 2 is made to contain a fluorescent agent (a fluorescent brightener) emitting first fluorescence by using ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength as an excitation light source, the fluorescent strengths obtainable when ultraviolet radiations with the first and second wavelengths are irradiated respectively to the recording material are measured by the reading device 92. Whereupon, when the second coating solution B is coated uniformly as shown in FIG. 1, such a measured result that both of the first and second fluorescence respectively indicate a certain fluorescent strength is detected in the whole area to which the two coating solutions are coated. On the other hand, when the second coating solution B is coated but not uniformly as shown in FIG. 6, such a measured result that both of the first and second fluorescence respectively indicate a certain fluorescent strength is detected in the area whereto the second coating solution B is coated (the area ultraviolet radiation p is irradiated), whereas such a measured result that the first fluorescence indicates a certain fluorescent strength but the second fluorescence indicates substantially no fluorescent strength is detected in the area whereto the second coating solution B is not coated (the area whereto ultraviolet radiation q is irradiated).

In the sixth pattern, when the resin layer 2b positioning at the porous layer 3 side in the support 2 is made to contain a fluorescent agent (a fluorescent brightener) emitting first fluorescence by using ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent (fluorescent brightener) emitting the first fluorescence by using ultraviolet radiation with the same wavelength as an excitation light source, fluorescent strengths of the two different types obtainable when ultraviolet radiation with a predetermined wavelength is irradiated to the recording material are measured by means of two reading device 92, respectively. Whereupon, when the second coating solution B is coated uniformly as shown in FIG. 1, a measured result indicating a certain fluorescent strength for the respective wavelengths of the two different types is detected in the whole area to which the two coating solutions are coated. On the other hand, when the second coating solution B is coated but not uniformly as shown in FIG. 6, a measured result indicating a certain fluorescent strength similar to the fluorescent strength described above is detected in the area whereto the second coating solution B is coated (the area ultraviolet radiation p is irradiated), whereas such a measured result that the fluorescent strength for one of the wavelengths of the two different types be different from the above is detected in the area whereto the second coating solution B is not coated (the area whereto ultraviolet radiation q is irradiated).

Next, as shown in FIG. 2, another embodiment for the ink jet recording material 1 provided with an undercoat layer 4 onto a support 2 and configured such that a first coating solution A is coated onto the undercoat layer 4 to form a porous layer 3 on the support 2 via the undercoat layer 4, wherein the undercoat layer 4 is provided with a property adapted to give a predetermined response to specific light and a second coating solution B is provided with a property adapted to give a response to specific light different from that of the undercoat layer 4, will be explained hereinbelow.

Specifically, this embodiment may be configured in the following patterns.

In the first pattern, when the undercoat layer 4 is made to contain an absorbing agent for ultraviolet radiation with a first wavelength, whereas the second coating solution B is made to contain an absorbing agent for ultraviolet radiation with a second wavelength different in the wavelength from the ultraviolet radiation with the first wavelength, the reflectances obtainable when the ultraviolet radiations with the first and second wavelengths are irradiated respectively to the recording material are measured by the reading device 92. Whereupon, when the second coating solution B is coated uniformly as shown in FIG. 2, such a measured result indicating that the reflectances for both of the ultraviolet radiations with the first and second wavelengths be low is detected in the whole area whereto the two coating solution are coated. On the other hand, when the second coating solution B is coated but not uniformly as shown in FIG. 7, such a measured result indicating that the reflectances for both of the ultraviolet radiations with the first and second wavelengths be low is detected in the area whereto the second coating solution B is coated (the area whereto ultraviolet radiation p is irradiated), whereas such a measured result indicating that the reflectance for the ultraviolet radiation with the first wavelength be low but the reflectance for the ultraviolet radiation with the second wavelength be high is detected in the area whereto the second coating solution B is not coated (the area whereto ultraviolet radiation q is irradiated).

In the second pattern, when the undercoat layer 4 is made to contain a fluorescent agent (a fluorescent brightener) emitting fluorescence by using ultraviolet radiation as an excitation light source, whereas the second coating solution B is made to contain a fluorescent deactivating agent for deactivating the fluorescence, the fluorescent strength obtainable when ultraviolet radiation is irradiated to the recording material is measured by the reading device 92. Whereupon, when the second coating solution B is coated uniformly as shown in FIG. 2, a measured result indicating a certain low fluorescent strength is detected in the whole area to which the two coating solutions are coated. On the other hand, when the second coating solution B is coated but not uniformly as shown in FIG. 7, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the third pattern, when the undercoat layer 4 is made to contain a fluorescent agent (a fluorescent brightener) emitting fluorescence by using ultraviolet radiation as an excitation light source, whereas the second coating solution B is made to contain an absorbing agent for ultraviolet radiation, the fluorescent strength obtainable when ultraviolet radiation is irradiated to the recording material is measured by the reading device 92. Whereupon, when the second coating solution B is coated uniformly as shown in FIG. 2, a measured result indicating a certain low fluorescent strength is detected in the whole area to which the two coating solutions are coated. On the other hand, when the second coating solution B is coated but not uniformly as shown in FIG. 7, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the fourth pattern, when the undercoat layer 4 is made to contain a fluorescent agent (a fluorescent brightener) emitting fluorescence by using ultraviolet radiation as an excitation light source, whereas the second coating solution B is made to contain an absorbing agent for light with a wavelength falling within the wavelength range of the fluorescence, the fluorescent strengths of the undercoat layer and the solution obtainable when ultraviolet radiation is irradiated thereto are measured by the reading device 92. Whereupon, when the second coating solution B is coated uniformly as shown in FIG. 2, a measured result indicating a certain low fluorescent strength is detected in the whole area to which the two coating solutions are coated. On the other hand, when the second coating solution B is coated but not uniformly as shown in FIG. 7, a measured result indicating a low fluorescent strength is detected in the area whereto the second coating solution B is coated (the area whereto ultraviolet radiation p is irradiated), whereas a measured result indicating a high fluorescent strength is detected in the area whereto the second coating solution B is not coated (the area whereto ultraviolet radiation q is irradiated).

In the fifth pattern, when the undercoat layer 4 is made to contain a fluorescent agent (a fluorescent brightener) emitting first fluorescence by using ultraviolet radiation with a first wavelength as an excitation light source, whereas the second coating solution B is made to contain a fluorescent agent (a fluorescent brightener) emitting second fluorescence by using ultraviolet radiation with a second wavelength different in the wavelength from the ultraviolet radiation with the first wavelength as an excitation light source, the fluorescent strengths obtainable when the ultraviolet radiations with the first and second wavelengths are irradiated to the recording material are measured, respectively, by the reading device 92. Whereupon, when the second coating solution B is coated uniformly as shown in FIG. 2, such a measured result indicating that both of the first and second fluorescence respectively indicate a certain fluorescent strength is detected in the whole area whereto the two coating solution are coated. On the other hand, when the second coating solution B is coated but not uniformly as shown in FIG. 7, such a measured result indicating that both of the first and second fluorescence respectively indicate a certain fluorescent strength is detected in the area whereto the second coating solution B is coated (the area whereto ultraviolet radiation p is irradiated), whereas such a measured result indicating that the first fluorescence indicates a certain fluorescent strength but the second fluorescence indicates substantially no fluorescent strength is detected in the area whereto the second coating solution B is not coated (the area whereto ultraviolet radiation q is irradiated).

In the sixth pattern, when the undercoat layer 4 is made to contain a fluorescent agent (a fluorescent brightener) emitting first fluorescence by using ultraviolet radiation with a predetermined wavelength as an excitation light source, whereas the second coating solution B is made to contain a second fluorescent agent (fluorescent brightener) emitting second fluorescence with a fluorescent spectrum different from that of the fluorescent agent (fluorescent brightener) emitting the first fluorescence by using ultraviolet radiation with the same wavelength, the fluorescent strengths of the two different types obtainable when the ultraviolet radiations with a predetermined wavelength is irradiated to the recording material are measured, respectively, by means of two reading device 92. Whereupon, when the second coating solution B is coated uniformly as shown in FIG. 2, a measured result indicating a certain fluorescent strength for the wavelengths of the two types is detected in the whole area whereto the two coating solution are coated. On the other hand, when the second coating solution B is coated but not uniformly as shown in FIG. 7, a measured result indicating a certain fluorescent strength similar to the above is detected in the area whereto the second coating solution B is coated (the area whereto ultraviolet radiation p is irradiated), whereas such a measured result indicating that the fluorescent strength for one of the wavelengths of the two types be different from the above is detected in the area whereto the second coating solution B is not coated (the area whereto ultraviolet radiation q is irradiated).

Consequently, the ink jet recording material 1 is provided as a product via the performance inspections as described above.

As described above, according to the ink jet recording material and method for manufacturing the ink jet recording material specified in the above-described embodiments for the present invention, it is concluded that the first coating solution for forming the porous layer containing a hydrophilic binder and the particulates is coated onto the support in the ink jet recording material, the second coating solution having a predetermined function and prepared so as to alter the property of the recording material to specific light depending on the presence or absence of the coating is coated onto the first coating solution having been coated, specific light is irradiated to the ink jet recording material to which the two coating solutions have been coated, the reaction of the recording material to the specific light is detected, and the determination as to whether the second coating solution is coated uniformly or not is made in such a manner that, if the response of the recording material based on the property of the second coating solution is detected in the whole area whereto the two coating solutions are coated, it is determined that the second coating solution has been coated uniformly, whereas if the reaction based on the property of the second coating solution is not detected, it is determined that the second coating solution was not coated uniformly.

With the inspection procedure described hereinabove, it is possible to inspect the coating condition of the second coating solution with high-speed operations and high accuracy.

Further, in another embodiment for the present invention, the recording material is configured such that the second coating solution has a predetermined function and provides the recording material with a property to specific light different from that of the recording material provided only with the first coating solution. Therefore, similarly to the recording material defined in the first aspect of this patent application, such a result that, when the second coating solution is coated uniformly, the response based on the property of the second coating solution be detected in the whole area whereto the two coating solutions are coated, whereas when the second coating solution is not coated uniformly, the response based on the property of the second coating solution be not detected in the area whereto the second coating solution is not coated are obtained.

In still another embodiment for the present invention, the recording material is configured such that the first coating solution is made not to contain an absorbing agent for specific non-visible light, whereas the second coating solution is made to contain an absorbing agent for specific non-visible light, and specific non-visible light is irradiated to the recording material coated with the two coating solutions to measure the reflectance for the non-visible light so that the determination as to whether the second coating solution is coated uniformly or not can be made. As a result, a measured result indicating a low reflectance for the specific non-visible light is detected in the whole area whereto the two coating solution are coated, whereas a measured result indicating a high reflectance for the specific non-visible light is detected in the area whereto the second coating solution is not coated.

In still another embodiment for the present invention, the recording material is configured such that the first coating solution is made to contain an absorbing agent for non-visible light with a first wavelength, whereas the second coating solution is made to contain an absorbing agent for non-visible light with a second wavelength different in the wavelength from the non-visible light with the first wavelength, and the respective non-visible lights with the first and second wavelengths are irradiated to the recording material coated with the two coating solutions to measure the reflectances for the two non-visible lights so that the determination as to whether the second coating solution is coated uniformly or not can be made. As a result, a measured result indicating low reflectances for both of the non-visible lights with the first and second wavelengths is detected in the whole area whereto the two coating solutions are coated when both of the first and second coating solution are coated uniformly, whereas such a measured result indicating that the reflectance for the non-visible light with the first wavelength be low but the reflectance for the non-visible light with the second wavelength be high is detected in the area whereto the first coating solution is coated but the second coating solution is not coated when the second coating solution is not coated uniformly.

In addition, in the area whereto the first coating solution is coated but not uniformly, a measured result indicating a high reflectance for the non-visible light with the first wavelength is detected.

Therefore, with the embodiment described hereinabove, the coating condition of the first coating solution as well can be inspected speedy with high accuracy.

In still another embodiment for the present invention, the recording material is configured such that the first coating solution is made to contain a fluorescent agent emitting fluorescence by using specific non-visible light as an excitation light source, whereas the second coating solution is made to contain a fluorescent deactivating agent for deactivating the fluorescence, and specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

Note that, because of high sensitivity to the fluorescence, the inspections based on the measurements of the fluorescent strengths can be carried out easily.

In still another embodiment for the present invention, the recording material is configured such that the first coating solution is made to contain a fluorescent agent emitting fluorescence by using specific non-visible light as an excitation light source, whereas the second coating solution is made to contain an absorbing agent for specific non-visible light, and the specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the first coating solution is made to contain a fluorescent agent emitting fluorescence by using specific non-visible light as an excitation light source, whereas the second coating solution is made to contain an absorbing agent for light with a wavelength falling within the wavelength range of the fluorescence, and the specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the first coating solution is made not to contain a fluorescent agent emitting fluorescence by using specific non-visible light as an excitation light source, whereas the second coating solution is made to contain a fluorescent agent emitting fluorescence by using specific non-visible light as an excitation light source, and the specific non-visible light is irradiated to the ink jet recording material coated with the two coating solutions to measure the fluorescent strength for the specific non-visible light so that the determination whether the second coating solution is coated uniformly or not can be made. As a result, a measured result indicating a certain fluorescent strength is detected in the whole area whereto the two coating solutions are coated when the second coating solution is coated uniformly, whereas a measured result indicating a fluorescent strength is detected in the area whereto the second coating solution is not coated when the second coating solution is coated but not uniformly.

In still another embodiment for the present invention, the recording material is configured such that the first coating solution is made to contain a fluorescent agent emitting first fluorescence by using non-visible light with a first wavelength as an excitation light source, whereas the second coating solution is made to contain a fluorescent agent emitting second fluorescence by using non-visible light with a second wavelength different in the wavelength from the non-visible light with the first wavelength as an excitation light source, and the non-visible lights with the first and second wavelengths are irradiated to the ink jet recording material coated with the two coating solutions to measure the fluorescent strengths for the two non-visible lights, respectively, so that the determination as to whether the second coating solution is coated uniformly or not can be made. As a result, such a measured result that the both of the first and second fluorescence respectively indicate a certain fluorescent strength is detected in the whole area whereto the two coating solutions are coated when the first and second coating solutions are coated uniformly, whereas such a measured result that the first fluorescence indicates a certain fluorescent strength but the second fluorescence indicates substantially no fluorescent strength is detected in the area whereto the first coating solution is coated but the second coating solution is not coated when the second coating solution is coated but not uniformly.

In addition, when the first coating solution is coated but not uniformly, such a measured result that the first fluorescence indicates substantially no fluorescent strength is detected in the area whereto the first coating solution is not coated.

In still another embodiment for the present invention, the recording material is configured such that the first coating solution is made to contain a fluorescent agent emitting first fluorescence by using non-visible light with a predetermined wavelength as an excitation light source, whereas the second coating solution is made to contain a second fluorescent agent emitting second fluorescence with a fluorescent spectrum different from that of the fluorescent agent emitting the first fluorescence by using the non-visible light with a predetermined wavelength as an excitation light source, and the non-visible light with a predetermined wavelength is irradiated to the ink jet recording material coated with the two coating solutions to measure the fluorescent strengths for the non-visible light with a predetermined wavelength at the wavelengths of the two different types so that the determination as to whether the second coating solution is coated uniformly or not can be made. As a result, a measured result indicating a certain fluorescent strength for the wavelengths of the two different types are detected in the whole area whereto the two coating solutions are coated when the first and second coating solutions are coated uniformly, whereas such a measured result that the fluorescent strength for one of the wavelengths of the two different types be different from the above is detected in the area whereto the first coating solution is coated but the second coating solution is not coated when the second coating solution is coated but not uniformly.

In addition, when the first coating solution is coated but not uniformly, a measured result indicating substantially no fluorescent strength is detected in the area whereto the first coating solution is not coated.

According to the embodiments for the present invention as described above, the support is provided with a property of giving a predetermined response to specific light and the second coating solution is provided with a property of giving a response different from that of the support to the specific light. Hence, similarly to the configuration defined in the first aspect of this patent application, the inspection leads to such a result that a reaction based on the property of the second coating solution is detected in the whole area whereto the two coating solutions are coated when the second coating solution is coated uniformly, whereas the reaction based on the property of the second coating solution is not detected in the area whereto the second coating solution is not coated when the second coating solution is coated but not uniformly.

In the other embodiment for the present invention, the recording material is configured such that the support is made to contain an absorbing agent for non-visible light with a first wavelength, whereas the second coating solution is made to contain an absorbing agent for non-visible light with a second wavelength different in the wavelength from the non-visible light with the first wavelength, and the non-visible lights with the first and second wavelengths are irradiated to the ink jet recording material coated with the two coating solutions to measure the reflectances for the two different non-visible light so that the determination as to whether the second coating solution is coated uniformly or not can be made. As a result, a measured result indicating low reflectances for both of the non-visible lights with the first and second wavelengths are detected in the whole area whereto the two coating solutions are coated when the second coating solution is coated uniformly, whereas such a measured result indicating that the reflectance for the non-visible light with the first wavelength be low but the reflectance for the non-visible light with the second wavelength be high is detected in the area whereto the second coating solution is not coated when the second coating solution is coated but not uniformly.

In still another embodiment for the present invention, the recording material is configured such that the support is made to contain a fluorescent agent emitting fluorescence by using specific non-visible light as an excitation light source, whereas the second coating solution is made to contain a fluorescent deactivating agent for deactivating the fluorescence, and the specific non-visible light is irradiated to the ink jet recording material coated with the two coating solutions to measure the fluorescent strength for the specific non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the support is made to contain a fluorescent agent emitting fluorescence by using specific non-visible light as an excitation light source, whereas the second coating solution is made to contain an absorbing agent for specific non-visible light, and the specific non-visible light is irradiated to the ink jet recording material coated with the two coating solutions to measure the fluorescent strength for the specific non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the support is made to contain a fluorescent agent emitting fluorescence by using specific non-visible light as an excitation light source, whereas the second coating solution is made to contain an absorbing agent for light with a wavelength falling within the wavelength range of the fluorescence, and the specific non-visible light is irradiated to the ink jet recording material coated with the two coating solutions to measure the fluorescent strength for the specific non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the support is made to contain a fluorescent agent emitting first fluorescence by using non-visible light with a first wavelength as an excitation light source, whereas the second coating solution is made to contain a fluorescent agent emitting second fluorescence by using non-visible light with a second wavelength different in the wavelength from the non-visible light with the first wavelength as an excitation light source, and the non-visible lights with the first and second wavelengths are irradiated to the ink jet recording material coated with the two coating solutions to measure the fluorescent strengths for the two non-visible lights, respectively, so that the determination as to whether the second coating solution is coated uniformly or not can be made. As a result, such a measured result that both of the first and second fluorescence respectively give a certain fluorescent strength is detected in the whole area whereto the two coating solutions are coated when the second coating solution is coated uniformly, whereas such a measured result that the first fluorescence gives a certain fluorescent strength but the second fluorescence gives substantially no fluorescent strength is detected in the area whereto the second coating solution is not coated when the second coating solution is coated but not uniformly.

In still another embodiment for the present invention, the recording material is configured such that the support is made to contain a fluorescent agent emitting first fluorescence by using non-visible light with a predetermined wavelength as an excitation light source, whereas the second coating solution is made to contain a second fluorescent agent emitting second fluorescence with a fluorescent spectrum different from that of the fluorescent agent emitting the first fluorescence by using non-visible light with a predetermined wavelength as an excitation light source, and the non-visible light with a predetermined wavelength is irradiated to the ink jet recording material coated with the two coating solutions to measure the fluorescent strengths for the non-visible light with a predetermined wavelength at the wavelengths of the two different types so that the determination as to whether the second coating solution is coated uniformly or not can be made. As a result, a measured result indicating a certain fluorescent strength for the wavelengths of the two different types is detected in the whole area whereto the two coating solutions are coated when the second coating solution is coated uniformly, whereas such a measured result that the fluorescent strength for one of the wavelengths of the two different types be different from the above is detected in the area whereto the second coating solution is not coated when the second coating solution is coated but not uniformly.

In still another embodiment for the present invention, the recording material is configured such that the support is provided thereon with the undercoat layer, the first coating solution is coated onto the undercoat layer to form the porous layer on the support via the undercoat layer, the undercoat layer is provided with a property to give a predetermined response to specific light, and the second coating solution is provided with a property to give a response different from that of the undercoat layer to specific light. As a result, similarly to the recording material defined in the first aspect of this patent application, a response based on the property of the second coating solution is detected in the whole area whereto the two coating solutions are coated when the second coating solution is coated uniformly, whereas the response based on the property of the second coating solution is not detected in the area whereto the second coating solution is not coated when the second coating solution is coated but not uniformly.

In still another embodiment for the present invention, the recording material is configured such that the undercoat layer is made to contain an absorbing agent for non-visible light with a first wavelength, whereas the second coating solution is made to contain an absorbing agent for non-visible light with a second wavelength different in the wavelength from the non-visible light with the first wavelength, and the non-visible lights with the first and second wavelengths are irradiated to the ink jet recording material coated with the two coating solutions to measure the reflectances for the two non-visible lights, respectively, so that the determination as to whether the second coating solution is coated uniformly or not can be made. As a result, such a measured result that the reflectances for both of the non-visible lights with the first and second wavelengths be low is detected in the whole area whereto the two coating solutions are coated when the second coating solution is coated uniformly, whereas such a measured result that the reflectance for the non-visible light with the first wavelength be low but the reflectance for the non-visible light with the second wavelength be high is detected in the area whereto the second coating solution is not coated when the second coating solution is coated but not uniformly.

In still another embodiment for the present invention, the recording material is configured such that the undercoat layer is made to contain a fluorescent agent emitting fluorescence by using specific non-visible light as an excitation light source, whereas the second coating solution is made to contain a fluorescent deactivating agent for deactivating the fluorescence, and the specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment, the recording material is configured such that the undercoat layer is made to contain a fluorescent agent emitting fluorescence by using specific non-visible light as an excitation light source, whereas the second coating solution is made to contain an absorbing agent for specific non-visible light, and the specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the undercoat layer is made to contain a fluorescent agent emitting fluorescence by using specific non-visible light as an excitation light source, whereas the second coating solution is made to contain an absorbing agent for light with a wavelength falling within the wavelength range of the fluorescence, and the specific non-visible light is irradiated to the ink jet recording material coated with the two coating solutions to measure the fluorescent strength for the non-visible light so that the determination as to whether the second coating solution is coated uniformly or not can be made. As a result, a measured result indicating a certain low fluorescent strength is detected in the whole area whereto the two coating solutions are coated when the second coating solution is coated uniformly, whereas a measured result indicating a high fluorescent strength is detected in the area whereto the second coating solution is not coated when the second coating solution is coated but not uniformly.

In still another embodiment for the present invention, the recording material is configured such that the undercoat layer is made to contain a fluorescent agent emitting first fluorescence by using non-visible light with a first wavelength as an excitation light source, whereas the second coating solution is made to contain a fluorescent agent emitting second fluorescence by using non-visible light with a second wavelength different in the wavelength from the non-visible light with the first wavelength as an excitation light source, and the non-visible lights with the first and second wavelengths are irradiated to the ink jet recording material coated with the two coating solutions to measure the fluorescent strengths for the two non-visible lights, respectively, so that the determination as to whether the second coating solution is coated uniformly or not can be made. As a result, such a measured result that both of the first and second fluorescence indicate a certain fluorescent strength, respectively, in the whole area whereto the two coating solutions are coated when the second coating solution is coated uniformly, whereas such a measured result that the first fluorescence gives a certain fluorescent strength but the second fluorescence gives substantially no fluorescent strength is detected in the area whereto the second coating solution is not coated when the second coating solution is coated but not uniformly.

In still another embodiment for the present invention, the recording material is configured such that the undercoat layer is made to contain a fluorescent agent emitting first fluorescence by using non-visible light with a predetermined wavelength as an excitation light source, whereas the second coating solution is made to contain a second fluorescent agent emitting second fluorescence with a fluorescent spectrum different from that of the fluorescent agent emitting the first fluorescence by using non-visible light with a predetermined wavelength as an excitation light source, and the non-visible light with a predetermined wavelength is irradiated to the ink jet recording material coated with the two coating solutions to measure the fluorescent strengths for the non-visible light with a predetermined wavelength at the wavelengths of the two different types, respectively, so that the determination as to whether the second coating solution is coated uniformly or not can be made. As a result, a measured result indicating a certain fluorescent strength for the wavelengths of the two different types is detected in the whole area whereto the two coating solutions are coated when the second coating solution is coated uniformly, whereas such a measured result that the fluorescent strength for one of the wavelengths of the two different types be different from the above is detected in the area whereto the second coating solution is not coated when the second coating solution is coated but not uniformly.

Further, in the above-described embodiments for the present invention, since the support is a non-water-absorbing support, an additive that provides a predetermined function and a property to specific light in the second coating solution never penetrates or diffuses into the support, contrary to the case of a water-absorbing support.

Further, in the embodiments for the present invention, since the support is a coated-paper of which both surfaces are coated with a thermoplastic resin, it is possible to concretely make the support into a non-water-absorbing support.

Note that the scope of the present invention will not be limited to the above-described embodiments, and various improvements and modifications in the configuration may be applied to the embodiments for the present invention within the scope without departing from the subject matter of the present invention.

The entire disclosure of Japanese Patent Application Nos. Tokugan 2004-161890 which was filed on May 31, 2004, and Tokugan 2004-308171 which was filed on Oct. 22, 2004, including specification, claims, drawings and summary are incorporated herein by reference in its entirety.

1. An ink jet recording material comprising:
a support;
a porous layer containing a hydrophilic binder and particulates, formed onto a support;
wherein a coating solution is provided onto the porous layer, the coating solution being adapted to make a property to a specific light different from a property of a lower structure.

2. The ink jet recording material of claim 1, wherein a difference made in the property to the specific light results from a difference between a property of the porous layer to the specific light and a property of the coating solution provided onto the porous layer to the specific light.

3. The ink jet recording material of claim 1, wherein a difference made in the property to the specific light results from a difference between a property of the support to specific light and a property of the coating solution provided onto the porous layer to the specific light.

4. The ink jet recording material of claim 1, wherein a difference made in the property to the specific light results from a difference between a property of an intermediate layer formed between the support and the porous layer to the specific light, and a property of the coating solution provided onto the porous layer to the specific light.

5. The ink jet recording material of claim 1, wherein a difference made in the property to the specific light results from such a condition that the lower structure does not contain an absorbing agent for a specific non-visible light and the coating solution provided onto the porous layer contains an absorbing agent for the specific non-visible light.

6. The ink jet recording material of claim 1, wherein a difference made in the property to the specific light results from such a condition that the lower structure contains an absorbing agent for a specific non-visible light with a first wavelength and the coating solution provided onto the porous layer contains an absorbing agent for a non-visible light with a second wavelength different in a wavelength from the non-visible light with the first wavelength.

7. The ink jet recording material of claim 1, wherein a difference made in the property to the specific light results from such a condition that the lower structure contains a fluorescent agent emitting a fluorescence by using a specific non-visible light as an excitation light source and the coating solution provided onto the porous layer contains a fluorescent deactivating agent for deactivating the fluorescence.

8. The ink jet recording material of claim 1, wherein a difference made in the property to the specific light results from such a condition that the lower structure contains a fluorescent agent emitting a fluorescence by using a specific non-visible light as an excitation light source and the coating solution provided onto the porous layer contains an absorbing agent for the specific non-visible light.

9. The ink jet recording material of claim 1, wherein a difference made in the property to the specific light results from such a condition that the lower structure contains a fluorescent agent emitting a fluorescence by using a specific non-visible light as an excitation light source and the coating solution provided onto the porous layer contains an absorbing agent for a light with a wavelength falling within a wavelength range of the fluorescence.

10. The ink jet recording material of claim 1, wherein a difference made in the property to the specific light results from such a condition that the lower structure does not contain a fluorescent agent emitting a fluorescence by using a specific non-visible light as an excitation light source and the coating solution provided onto the porous layer contains a fluorescent agent emitting a fluorescence by using the specific non-visible light as an excitation light source.

11. The ink jet recording material of claim 1, wherein a difference made in the property to the specific light results from such a condition that the lower structure contains a fluorescent agent emitting a first fluorescence by using a non-visible light with a first wavelength as an excitation light source and the coating solution provided onto the porous layer contains a fluorescent agent emitting a second fluorescence by using a non-visible light with a second wavelength different in a wavelength from the non-visible light with the first wavelength as an excitation light source.

12. The ink jet recording material of claim 1, wherein a difference made in the property to the specific light results from such a condition that the lower structure contains a fluorescent agent emitting a first fluorescence by using a non-visible light with a predetermined wavelength as an excitation light source and the coating solution provided onto the porous layer contains a fluorescent agent emitting a second fluorescence with a fluorescent spectrum different from that of the fluorescent agent emitting the first fluorescence by using the non-visible light with the predetermined wavelength as an excitation light source.

13. A method for manufacturing an ink jet recording material comprising:
forming a porous layer containing a hydrophilic binder and particulates on a support;
providing a coating solution on the porous layer to form the ink jet recording material, the coating solution being adapted to make a property to a specific light different from a property of the lower structure; and
detecting a response of the ink jet recording material to the specific light by irradiating the specific light.

14. The method of claim 13, wherein the response to the specific light results from such a condition that the lower structure does not contain an absorbing agent for a specific non-visible light and the coating solution provided onto the porous layer contains an absorbing agent for the specific non-visible light.

15. The method of claim 13, wherein the response to the specific light results from such a condition that the lower structure does not contain an absorbing agent for a non-visible light with a first wavelength and the coating solution provided onto the porous layer contains an absorbing agent for a non-visible light with a second wavelength different in a wavelength from the non-visible light with the first wavelength.

16. The method of claim 13, wherein the response to the specific light results from such a condition that the lower structure contains a fluorescent agent emitting a fluorescence by using a specific non-visible light as an excitation light source and the coating solution provided onto the porous layer contains a fluorescent deactivating agent for deactivating the fluorescence.

17. The method of claim 13, wherein the response to the specific light results from such a condition that the lower structure contains a fluorescent agent emitting a fluorescence by using a specific non-visible light as an excitation light source and the coating solution provided onto the porous layer contains an absorbing agent for the specific non-visible light.

18. The method of claim 13, wherein the response to the specific light results from such a condition that the lower structure contains a fluorescent agent emitting a fluorescence by using a specific non-visible light as an excitation light source and the coating solution provided onto the porous layer contains an absorbing agent for a light with a wavelength falling within a wavelength range of the fluorescence.

19. The method of claim 13, wherein the response to the specific light results from such a condition that the lower structure does not contain a fluorescent agent emitting a fluorescence by using a specific non-visible light as an excitation light source and the coating solution provided onto the porous layer contains a fluorescent agent emitting a fluorescence by using the specific non-visible light as an excitation light source.

20. The method of claim 13, wherein the response to the specific light results from such a condition that the lower structure contains a fluorescent agent emitting a first fluorescence by using a non-visible light with a first wavelength as an excitation light source and the coating solution provided onto the porous layer contains a fluorescent agent emitting a second fluorescence by using a non-visible light with a second wavelength different in a wavelength from the non-visible light with the first wavelength as an excitation light source.

21. The method of claim 13, wherein the response to the specific light results from such a condition that the lower structure contains a fluorescent agent emitting a first fluorescence by using a non-visible light with a predetermined wavelength as an excitation light source and the coating solution provided onto the porous layer contains a fluorescent agent emitting a second fluorescence with a fluorescent spectrum different from that of the fluorescent agent emitting the first fluorescence by using the non-visible light with a predetermined wavelength as an excitation light source.
